(19) United States
(12) Patent Application Publication
(10) Pub. No.: US 2004/0015423 A1
(43) Pub. Date: Jan. 22, 2004

(54) Method and apparatus for managing performance of multiple games

(76) Inventors: Jay S. Walker, Ridgefield, CT (US); James A. Jorasch, Stamford, CT (US); Russell P. Sammon, San Francisco, CA (US); Michael D. Downs, Stamford, CT (US)

Correspondence Address: WALKER DIGITAL, FIVE HIGH RIDGE PARK, STAMFORD, CT, 06905, US

(21) Appl. No.: 10/420,069

(22) Filed: Apr. 21, 2003

Related U.S. Application Data
(60) Provisional application No. 60/374,343, filed on Apr. 19, 2002.

(51) Int. Cl. G06F 17/60

(52) U.S. Cl. 705/34

(57) ABSTRACT

In accordance with one or more embodiments, a method for managing games for use on gaming devices is presented, wherein the method comprises determining a measure of performance of a game, and determining a payment due to a provider of the game based on the measure of performance of the game. In one or more embodiments, the measure of performance may be used to determine whether to keep the game enabled on one or more gaming devices.

### CROSS-REFERENCE TO RELATED APPLICATIONS

The present Application claims the benefit of:

(i) U.S. Provisional Patent Application No. 60/374,343 filed Apr. 19, 2002, entitled “GAMING DEVICE METHODS AND APPARATUS EMPLOYING FEATURE MANAGEMENT”, the entirety of which is incorporated by reference herein for all purposes; and

(ii) U.S. patent application Ser. No. 60/373761, [Attorney Docket No. 02-015] filed Apr. 18, 2003, entitled “METHOD AND APPARATUS FOR ENABLING A PLAYER TO SELECT FEATURES ON A GAME MACHINE”, the entirety of which is incorporated by reference herein for all purposes; which claims the benefit of U.S. Provisional Patent Application No. 60/373,761 filed Apr. 18, 2002.

The present Application is related to the following commonly-owned, co-pending U.S. patent applications:

(i) U.S. patent application Ser. No. 09/603,677, filed Jun. 26, 2000, entitled “METHOD AND APPARATUS FOR SELECTING A SUPPLEMENTAL PRODUCT TO OFFER FOR SALE DURING A TRANSACTION”, the entirety of which is incorporated by reference herein for all purposes; and

(ii) U.S. patent application Ser. No. 09/993,228, filed Nov. 14, 2001, entitled “METHOD AND APPARATUS FOR DYNAMIC RULE AND/OR OFFER GENERATION”, the entirety of which is incorporated by reference herein for all purposes.

### BACKGROUND

The present invention relates generally to methods and apparatus for managing the enabling of games on gaming devices.

Gaming devices (e.g., reeled slot machines, video poker machines, video keno machines, video blackjack, and video bingo machines) generate more than $15 billion per year in revenue for casinos in the United States alone. This figure accounts for more than half of the gaming revenue for a typical United States casino. The situation is similar in other countries in which gaming devices are popular, such as Australia. Accordingly, casino operators and other operators of gaming devices are interested in increasing the enjoyment of playing gaming devices in order to maintain or increase this level of revenue.

### BRIEF DESCRIPTION OF THE FIGURES

FIG. 1A is a flowchart depicting an exemplary process consistent with one or more embodiments of the present invention.

FIG. 1B is a flowchart depicting an exemplary process consistent with one or more embodiments of the present invention.

FIG. 1C is a flowchart depicting an exemplary process consistent with one or more embodiments of the present invention.

FIG. 1D is a flowchart depicting an exemplary process consistent with one or more embodiments of the present invention.

FIG. 2A is a block diagram of an exemplary system consistent with one or more embodiments of the present invention.

FIG. 2B is a block diagram of another exemplary system consistent with one or more embodiments of the present invention.

FIG. 3 is a block diagram of an exemplary computer consistent with one or more embodiments of the present invention.

FIG. 4 is a block diagram of an exemplary gaming device consistent with one or more embodiments of the present invention.

FIG. 5 is a table illustrating an exemplary data structure of a game database consistent with one or more embodiments of the present invention.

FIG. 6 is a table illustrating an exemplary data structure of a condition database consistent with one or more embodiments of the present invention.

FIG. 7 is a table illustrating an exemplary data structure of a gaming device database consistent with one or more embodiments of the present invention.

FIG. 8 is a table illustrating an exemplary data structure of a player database consistent with one or more embodiments of the present invention.

FIG. 9A is a table illustrating an exemplary data structure of a performance database consistent with one or more embodiments of the present invention.

FIG. 9B is a table illustrating another exemplary data structure of a performance database consistent with one or more embodiments of the present invention.

FIG. 9C is a table illustrating another exemplary data structure of a performance database consistent with one or more embodiments of the present invention.

FIGS. 9D-9E is a table illustrating another exemplary data structure of a performance database consistent with one or more embodiments of the present invention.

FIG. 10A is a table illustrating an exemplary data structure of a payment database consistent with one or more embodiments of the present invention.

FIG. 10B-10C is a table illustrating another exemplary data structure of a payment database consistent with one or more embodiments of the present invention.

FIG. 11 is a plan view of an exemplary gaming device consistent with at least one embodiment of the present invention.

FIG. 12 is a flowchart depicting an exemplary process consistent with one or more embodiments of the present invention.

### DETAILED DESCRIPTION

Some types of gaming devices (e.g., video lottery) may be enabled to offer one or more different games. Applicants have recognized that, in some embodiments, operators of gaming devices may find it appealing to be able to take advantage of methods and apparatus for determining which games (or combinations of games) to enable for use on one or more gaming devices. For example, some types of operators may find it appealing to be able to determine which one or more games of a plurality of games are likely to be most appealing to players, to increase revenues of a gaming device, and/or to increase profitability of a gaming device.

Some types of gaming devices may be enabled to offer one or more different types of parameters, options, and other features for affecting the operation of a gaming device (and/or of a game provided on the gaming device). Applicants have recognized that owners and operators of gaming devices may also benefit from methods and apparatus for determining which features (or combinations of features) to make available to players of gaming devices. U.S. patent application Ser. No. 60/374,343, [Attorney Docket No. 02-016] filed concurrently herewith, entitled “METHOD AND APPARATUS FOR MANAGING FEATURES ON A GAMING DEVICE”, the entirety of which is incorporated by reference herein for all purposes, relates generally to managing the availability of different features on a gaming device. The present application, in contrast, relates generally to managing the availability of different games on a gaming device.

Applicants have recognized that owners and operators of gaming devices may benefit from being able to determine various measures of the performance of a game and/or of a gaming device. For example, an indication of an amount that an enabled game has been used on a slot machine, or an indication of how much revenue was taken in at a gaming device at which the game is enabled, may be useful in managing one or more games on one or more gaming devices (e.g., in determining whether to disable a particular game or to keep it enabled on one or more gaming devices). In another example, by tracking information related to use of a gaming device, an increased profitability of the gaming device may be correlated to one or more games enabled at the gaming device.

Applicants have recognized that owners and operators of gaming devices, as well as providers of games for use on gaming devices, may find it appealing to be able to determine a payment based on the performance of a game (and/or of a gaming device on which the game is enabled). For example, some operators of gaming devices may benefit from being able to pay a provider of a game an amount that is based on how long the game is enabled for use, how many machines are enabled to provide the game, or how often the game is actually used by players. Thus, gaming device operators may be able to enter into performance-based agreements with providers in which the operator can compensate the provider, for example, based on a cost per use of the game, or a cost per time the game is in use (or merely enabled for use). In another example, some operators may find it appealing to be able to determine a payment based on an increase in the use and/or profitability of a gaming device.

Applicants have also recognized that enhancing the operation of a gaming device by enabling and/or disabling the use of one or more particular games (or combinations of games) on the gaming device may serve to distinguish the gaming device, and may provide a more satisfying entertainment experience to players, thus attracting more players to such a gaming device.

Applicants have also recognized that modifying the experience of a player at a gaming device, by enabling and/or disabling the use of one or more particular games with the gaming device, may serve to increase the player's use of the gaming device, leading to increased revenues for owners and operators of gaming devices, and may increase the profitability of the gaming device.

Applicants have further recognized that manufacturers, owners, and operators of gaming devices may benefit from a degree of flexibility in determining which of a plurality games should be available for use on a gaming device. Applicants have also recognized that manufacturers, owners, and operators of gaming devices may find it appealing to have a game automatically enabled or disabled on a gaming device in accordance with various predetermined conditions.

Accordingly, the present invention comprises systems and methods for managing games for use on gaming devices. In accordance with one or more embodiments, a game is enabled for use on one or more gaming devices, and an indication of performance of the game (e.g., a number of times the game is selected for play by players) is determined. In some embodiments, a payment (e.g., a royalty fee) is also determined based on the performance of the game.

For example, according to an exemplary embodiment, a new video poker game, “All-Star Poker”, is licensed by a casino from the game's developer. The casino then enables the game for use on five game terminals in the casino, making the game available to players playing the machines. Some of the game terminals offer one or more other types of games, such as video blackjack games and video keno games, and some of the terminals include other video poker games. During a brief trial period of two days, different types of information relating to interactions of players with the game terminals (e.g., player information, game information, information about the game terminals, information about the players' use of various games) are transmitted to a casino server and stored. During the two-day period, for example, “All-Star Poker” was played more than one hundred times by eighteen different players. Some players selected the “All-Star Poker” from a displayed list of “New Games”. One player who was playing a different video poker game was displayed an offer inviting her to play “All-Star Poker”, and pressed an “OK” button on the game terminal's touch screen to accept the offer. On one of the game terminals, “All-Star Poker” was played for a total of three hours during the two-day period. The average coin-in per hour for the two-day period while the “All-Star Poker” game was enabled was higher than the machine's average during the same two days of the previous week; the average coin-in per hour for the three hours while the new game was actually being played was higher yet. After the two-day trial period, a payment was determined based on the number of times “All-Star Poker” was played and a per-play rate, and the casino arranged to have the payment provided to the licensor. The casino, pleased with the performance of the game, also enabled “All-Star Poker” on fifteen more game terminals.

According to some embodiments, multiple games may be enabled simultaneously on a single gaming device. For example, a player may be able to choose to play a video poker game, a reeled slot game, and/or a video blackjack game at one game terminal. According to other embodiments, a game may not be compatible with a gaming device. For example, it may not be possible for a game terminal to provide both a first game and a second game (e.g., if the first game requires a second video screen that is not available at the game terminal). Therefore, the two games may not be available on the same game terminal.

According to one or more embodiments of the present invention, a game may be enabled for use on one or more gaming devices. According to some embodiments of the present invention, enabling a game for use on a gaming device includes making the game available for selection (e.g., for play) on the gaming device.

In one or more embodiments of the present invention, enabling a game for use on a gaming device means that the game may be offered to a player at the gaming device.

In some embodiments of the present invention, enabling a game for use on a gaming device may comprise indicating that the game is allowed to be played on the gaming device, regardless of whether it is actually ever played. In some embodiments, an indication that a game is permitted for use on one or more gaming devices may be stored in a data structure on a computer-readable medium (e.g., in a gaming device database).

In some embodiments, enabling a game on a gaming device comprises providing appropriate instructions (e.g., in computer program code) to the gaming device that the gaming device may execute in order to provide the game.

In some embodiments, if a game is enabled, then a player is able to play the game when operating the gaming device. For example, a player may wager on a play of a slot machine game if the game is enabled for use on a gaming device.

According to some embodiments, a player may play one or more games on a gaming device. In some embodiments, a player may request that one or more games be made available on a gaming device. In some embodiments, the player may select the game to play in response to a displayed indication of the game, such as a menu list of games available on the gaming device. According to some embodiments, a player may be able to play only games that are enabled for a gaming device; in other embodiments, the player may be able to request to play a game that is not yet enabled.

Apparatus and methods which, among other things, permit and enable various ways of displaying indications of available games to players and of allowing players to select games to play on a gaming device, and which are appropriate for use in accordance with the present invention are disclosed in pending U.S. patent application Ser. No. 60/373,761 [Attorney Docket No. 02-015], filed Apr. 18, 2003, entitled “METHOD AND APPARATUS FOR ENABLING A PLAYER TO SELECT FEATURES ON A GAMING DEVICE”, the entirety of which is incorporated herein by reference as part of the present disclosure. That application discloses an apparatus and method, which permits and enables various ways of displaying indications of available features to players and of allowing players to select features for play of a gaming device.

In one or more embodiments of the present invention, the player may receive an offer to enable and/or play one or more games. In some embodiments, a player may be offered the play of one or more games in exchange for a fee or other consideration. In other embodiments, a player may pay a fee or provide other consideration in order to disable a game on a gaming device. Alternatively, a player may be able to enabled and/or disable a game on a gaming device free of charge.

A cost or fee associated with the enabling and/or play of a game by a player may be based on many factors, including, but not limited to:

(i) How long a player plays a game/How long the game is enabled. For example, a player may be charged $0.05 per minute while he plays a game on a game terminal.

(ii) A cost per play. For example, a player may pay $0.50 for each play of an “All-Star Poker” game.

(iii) One or more benefits (e.g., payouts) received by a player while playing a game. For example, a player may pay a tax of 5% of the value of his prizes won while playing a game, in exchange for being able to play the game on a gaming device.

According to some alternative embodiments, a player may not be able to select what game(s) are available for play on a gaming device. For example, the gaming device may offer a fixed set of one or more games (e.g., as established by a casino). In another example, once a game is enabled, a player and/or a gaming device may not be able to disable the game (e.g., the game will still be available for selection).

According to one or more embodiments of the present invention, if a game is incompatible with a gaming device, or otherwise unsuitable for enabling on the gaming device, then a gaming device or a computer (e.g., a game terminal server) may be prevented from enabling one or more of the incompatible games. Information about the compatibility of a game with a gaming device, or type of gaming device, may be stored in a data structure (e.g., a game database).

The scope of the present invention and embodiments thereof may be understood more fully with reference to the following figures. The leftmost digit(s) of a reference numeral typically identifies the figure in which the reference numeral first appears. It should be noted that the embodiments described with reference to the following figures are presented for illustrative purposes only and are not meant to be limiting in any sense. Further, although particular features of the present invention may be described with reference to one or more particular embodiments or figures, it should be understood that such features are not limited to usage in the one or more particular embodiments or figures with reference to which they are described.

Embodiments of the present invention will first be introduced by means of flowcharts that illustrate some basic processes that may be utilized by an entity practicing the present invention. The system infrastructure will then be described with reference to block diagrams of exemplary systems and devices that may be utilized by an entity practicing the present invention. Exemplary data structures illustrating tables that may be used when practicing some embodiments of the present invention will then be described, along with corresponding flowcharts that illustrate exemplary processes that utilize the exemplary tables.

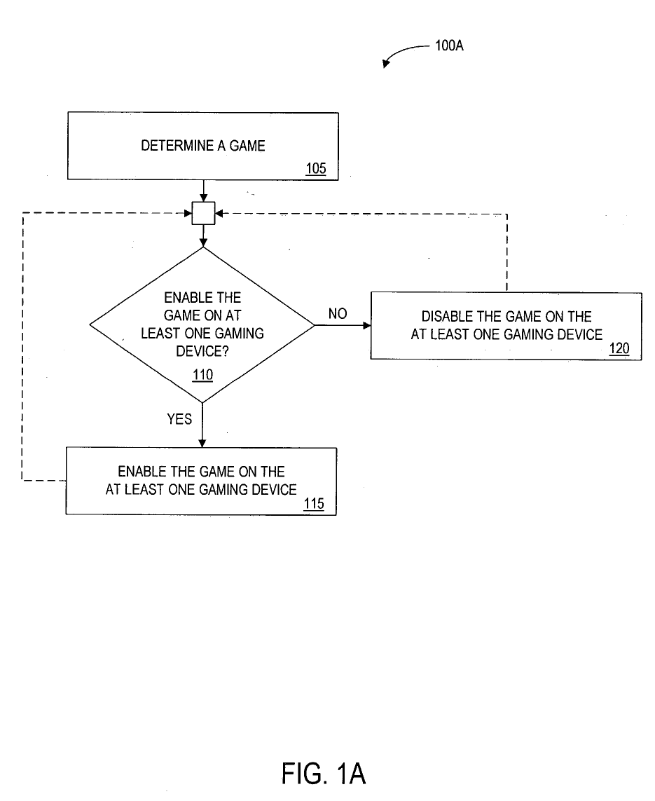

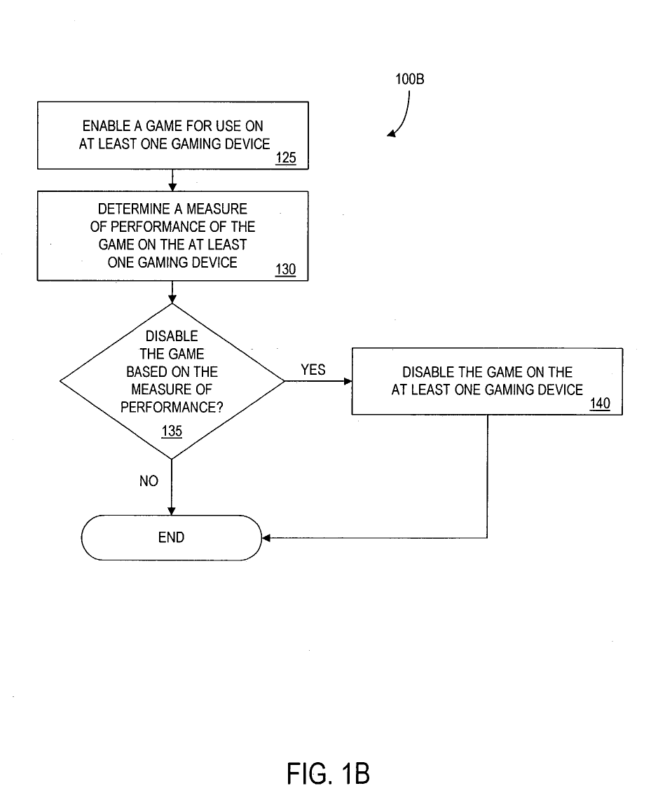

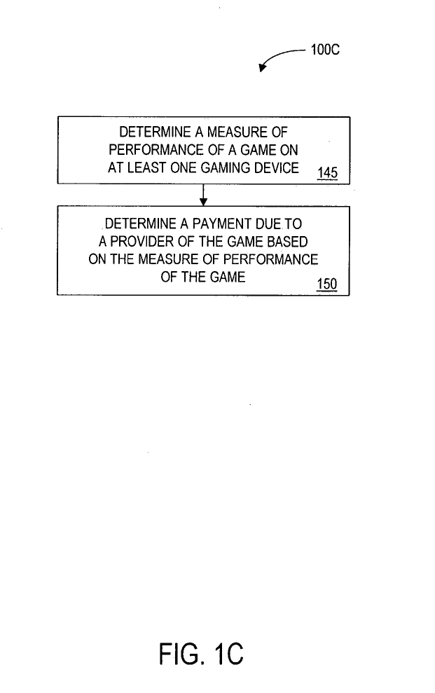

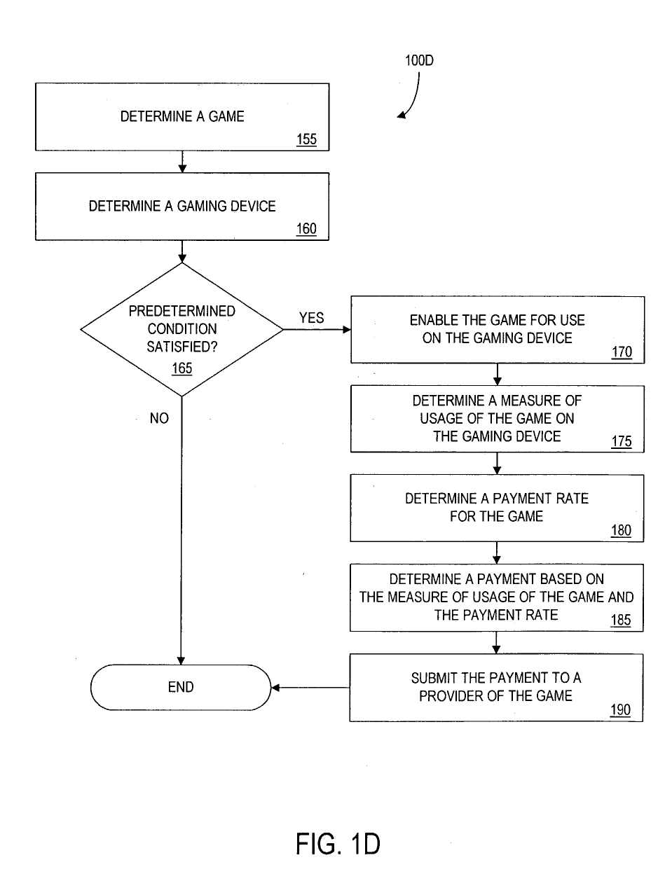

Referring now to FIG. 1A, a flowchart illustrates a process 100A that is consistent with one or more embodiments of the present invention. The process 100A is a method for determining whether a game should be enabled on a gaming device. The process 100A, and all other processes described herein unless expressly specified otherwise, may be performed by a gaming device, a computer (e.g., a game terminal server) in communication with the gaming device, a peripheral device in communication with a gaming device, a peripheral device server and/or a combination thereof Each of these devices is described in detail below. Further, the process 100A, and all other processes described herein unless expressly specified otherwise, may include steps in addition to those expressly depicted in the Figures or described in the specification without departing from the spirit and scope of the present invention. Similarly, the steps of process 100A and any other process described herein, unless expressly specified otherwise, may be performed in an order other than depicted in the Figures or described in the specification, as appropriate.

Referring to step 105, a game is determined. In step 110, the entity determines whether the determined game should be enabled on at least one gaming device. In some embodiments the determination may comprise determining whether or not to enable a disabled game. In other embodiments, the game may already be enabled on one or more of the at least one gaming device, and the determination may thus comprise determining whether or not to keep the game enabled (e.g., on those gaming devices on which it is already enabled).

In some embodiments, determining whether a game should be enabled may be based on a condition. FIG. 1D depicts a process, consistent with one or more embodiments of the present invention, in which a game may be enabled based on whether a predetermined condition is satisfied.

It will be readily understood that determining whether a game should be enabled may comprise determining whether the game should be disabled. In some embodiments, determining whether a game should be enabled may be based on a measure of performance of the game. FIG. 1B depicts a process, consistent with one or more embodiments of the present invention, in which a measure of performance of a game is determined and the game may be disabled based on the measure of performance. Note that FIG. 1B and FIG. 1D illustrate only two possible methods for determining whether to enable (or whether to disable) a game for use on a gaming device.

A rules-based system appropriate for use in accordance with the present invention is disclosed in pending U.S. patent application Ser. No. 09/603,677, filed Jun. 26, 2000, entitled “METHOD AND APPARATUS FOR SELECTING A SUPPLEMENTAL PRODUCT TO OFFER FOR SALE DURING A TRANSACTION”, the entirety of which is incorporated herein by reference as part of the present disclosure.

According to one or more embodiments of the present invention, a game may be enabled or disabled for use on one or more gaming devices based on one or more rules. In one embodiment, such one or more rules may be associated with, for example, a predetermined condition, as described in FIG. 1D. In another embodiment, such one or more rules may be associated with the player who is operating a gaming device, with the owner of the gaming device, or with a provider of a game. In yet another embodiment, the one or more rules may be associated with the gaming device that a player is operating (e.g., the same one or more rules is used to determine whether the game should be enabled regardless of who the player is).

In yet another embodiment, the one or more rules may be selected randomly. In one exemplary method of selecting a rule randomly, a random number generated by a random number generator may be determined and a table of rules may be accessed in which each rule corresponds to a respective random number, or range of random numbers that may be generated by a random number generator.

As is known in the art, a rules-based system may be modified by an adaptive system in order to increase the performance of the rules-based system. An adaptive system which, among other things, may create its own rules and/or modify rules in accordance with desired performance, and which is appropriate for use in accordance with the present invention is disclosed in pending U.S. patent application Ser. No. 09/993,228, filed Nov. 14, 2001, entitled “METHOD AND APPARATUS FOR DYNAMIC RULE AND/OR OFFER GENERATION”, the entirety of which is incorporated herein by reference as part of the present disclosure. That application discloses an apparatus and method, which permits and enables rules-based applications (such as a system that provides customers with dynamically-priced upsell offers) to become “self improving” and thus increase performance over time.

Such an adaptive system can adjust at least some of the rules in accordance with at least one measure of performance of one or more games and/or gaming devices. For example, an adaptive system can modify rules such that games that have previously proven popular among players of gaming devices after they receive a payout of over ten coins (e.g., as indicated by the number of times players have played the game within ten minutes after receiving the payout) are made the subject of explicit offers to players at the time they receive such a payout. In another example, an adaptive system can modify rules such that games that have previously tended to generate less revenue on game terminals during certain times of the day are disabled during those times (e.g., so that players play other enabled games). In yet another example, an adaptive system can modify rules such that when the theoretical win per minute of a group of game terminals has previously increased more since a first game was enabled on the game terminals than since a second game was enabled on the game terminals, the second game is never enabled while that first game is enabled. Various other types of measures of performance are described herein, and may be used in accordance with one or more embodiments of the present invention to provide for an adaptive rules-based system for determining whether one or more games should be enabled or disabled.

By allowing for the adjustment of one or more rules based on one or more measures of performance, some embodiments of the present invention may improve the profitability of gaming devices over time. In some embodiments of the present invention, as discussed herein, an operator of gaming devices may make payment to a provider of a game (e.g., a game developer) based on usage of the game. Accordingly, by making improvements to the rules effectively governing which games should be enabled or disabled in various circumstances, based on one or more measures of performance, the operator may reduce the enablement and/or usage of an underperforming game, thereby potentially reducing the amount owed to the game's provider.

Some adjustments of the rules may be based on factors other than, or in addition to, one or more measures of performance. As discussed above, a rule for determining whether a game should be enabled may be selected or generated at random from a table of rules. The effectiveness of the randomly-selected rule may then be evaluated in accordance with one or more measures of performance, further assisting the rules-based system in adapting to improve the performance of the system.

Referring again to process 100A (FIG. 1A), if the game should be enabled, in step 115 the game is enabled on the at least one gaming device. In some embodiments, enabling the game may comprise storing an indication in a database (e.g., a software flag) and/or transmitting a signal to a gaming device or peripheral device. If the game is already enabled, in some embodiments enabling the game may comprise any operations necessary to keep the game enabled, or to extend a period of time for which the game is to be enabled.

Referring to step 120, if the game should not be enabled, the game is disabled on the at least one gaming device. It will be understood that in some embodiments disabling a game may comprise one or more operations to disable a game that is enabled, or may comprise any operations necessary to keep a game disabled (e.g., if it is already disabled).

As depicted in FIG. 1A, in some optional embodiments some steps of the process 100A may be iterative. For example, after step 115 and/or after step 120, operation of the process may return (e.g., after a period of time, in response to a signal) to step 110 for determining whether the game should be enabled. In this way, an entity may monitor and/or re-evaluate (e.g., periodically, intermittently, or at any time) whether the game should be enabled on the at least one gaming device.

Referring now to FIG. 1B, a flowchart illustrates a process 100B that is consistent with one or more embodiments of the present invention. The process 100B is a method for disabling a game based on the performance of the enabled game. Referring to step 125, a game is enabled for use on one or more gaming devices. In some embodiments, the game may be enabled automatically based on any one or more of various predetermined conditions (e.g., if a player has wagered more than a predetermined amount within ten minutes, or in response to a received signal). In other embodiments, the game may be enabled manually by or on behalf of an operator of a gaming device (e.g., by a casino representative operating a computer).

In step 130, a measure of performance of the game on the at least one gaming device is determined. In some embodiments, determining a measure of performance of a game comprises determining a measure of usage of the game on a gaming device. FIG. 1D depicts a process, consistent with one or more embodiments of the present invention, in which a measure of usage of a game is determined. Note that FIG. 1D illustrates only one possible method for determining a measure of performance. Other methods will be described herein, and still others may be apparent to those skilled in the art upon reading the present disclosure.

Referring again to process 100B (FIG. 1B), in step 135 it is determined whether the enabled game should be disabled based on the measure of performance. If the game should not be disabled, the process ends; otherwise, in step 140 the game is disabled and the process ends.

Referring now to FIG. 1C, a flowchart illustrates a process 100C that is consistent with one or more embodiments of the present invention. The process 100C is a method for determining a payment due to a provider of a game. Referring to step 145, a measure of performance of a game on at least one gaming device is determined. In some embodiments, determining the measure of performance comprises determining a measure of usage of a game on a gaming device (e.g., an amount of coin-in, an amount of time that the game was played on the gaming device). ). In other embodiments, determining the measure of performance may include determining a transaction volume for accepted product/service offers that were provided to players during play of the game (e.g., indicating a willingness of customers to accept offers during that particular game).

In step 150, a payment due to a provider of the game is determined, based on the measure of performance of the game. In some embodiments, determining a payment comprises determining a payment rate associated with a game. FIG. 1D depicts a process, consistent with one or more embodiments of the present invention, in which a measure of usage of a game and a payment rate for a game are determined, and a payment is determined based on the measure of usage and the payment rate.

Note that FIG. 1D illustrates only one possible method for determining a payment due to a provider of a game. Some embodiments may include identifying one or more parties to whom payment is due, including one or more providers of the game. Providers who may be owed payment (e.g., based on usage of the game) include manufacturers of gaming devices or game manufacturers, holders of intellectual property related to a game (e.g., holders of patents, trademarks, copyrights, or trade secrets), and licensors of a game. Payment may be based on licensing, leasing, renting, or game usage agreements between a provider (or providers) of a game or gaming device, and a casino or other owner, lessee, or operator of a gaming device. For example, a casino may agree to pay a provider of a game 10% of the net profits obtained from play of a game on a gaming device. In another example, a gaming manufacturer may be entitled to 1% of revenue generated at a gaming device while a game is played. In yet another example, a proprietor of a game may be owed payment of $0.50 each time a game is played on a gaming device. Other methods for determining payment will be described herein, and still others may be apparent to those skilled in the art upon reading the present disclosure.

Referring now to FIG. 1D, a flowchart illustrates a process 100D that is consistent with one or more embodiments of the present invention. The process 100D is a method for enabling a game and determining a payment. Referring to step 155, a game is determined. In step 160 a gaming device is determined. In step 165 it is determined whether a predetermined condition has been satisfied. The predetermined condition, in the context of process 100D, is a condition that must be satisfied in order for the game determined in step 155 to be enabled on the gaming device determined in step 160.

Some of the various types of information on which predetermined conditions may be based, and which may be used to determine whether a predetermined condition is satisfied, are discussed herein and with reference to the accompanying figures. In some embodiments, for example, a predetermined condition will be related to information about the game whose enablement is being determined. In other embodiments, the predetermined condition may be related to information about one or more other games. For example, a condition for enabling one game on a gaming device may be satisfied if another game has been used at that gaming device for more than a predetermined period of time.

Note that more than one predetermined condition may be available and/or necessary for satisfaction. In such embodiments, the process 100D may continue to step 170 if any one of a plurality of predetermined conditions is satisfied. Alternatively, a combination of predetermined conditions may each need to be satisfied in order for the process 100D to continue to step 170.

If it is determined, in step 165, that the predetermined condition has not been satisfied, the process 100D ends. If it is determined, on the other hand, that the condition has been satisfied, then the process 100D continues to step 170, in which the game is enabled for use on the determined gaming device. In step 175, a measure of usage of the game on the gaming device is determined. Various measures of usage are described herein. In some embodiments, for example, the measure of usage is an amount of coin-in at the gaming device (e.g., based on wagers for play of the game).

In step 180, a payment rate for the game is determined. In step 185 a payment is determined based on the measure of usage of the game and the payment rate. For example, a rate of $0.02 per minute of play of the game is determined (e.g., by accessing a payment database entry corresponding to the game), and it is determined that the game was played for a total of 2,034 minutes. Accordingly, a payment amount of $40.68 would be determined.

In step 190 the payment is submitted to a provider of the game, and the process 100D ends. For example, the $40.68 is provided to a licensor of the game. Payment may be submitted to a party in any manner well known in the art (e.g., by initiating an electronic transfer of funds), and need not be described in further detail.

Applicants have recognized that the accumulation, storing, and/or analysis of various types of information may be helpful in the management of games on gaming devices. Many types of information are discussed herein. Some types of information may be helpful, for example, in determining whether a game should be enabled or disabled. Some types of information may be useful, for example, in determining a payment due to a provider of a game. Some types of information, for example, may be useful for both determining whether a game should be enabled or disabled and for determining a payment due to a provider of a game. Some types of information may be useful in establishing rules in a rules-based system, and/or for establishing predetermined conditions.

Examples of types of information that may be helpful in managing games for use on one or more gaming devices include, but are not limited to:

(i) information about performance of one or more games;

(ii) information about usage of one or more games;

(iii) information about usage of one or more gaming devices;

(iv) information about profitability of one or more games;

(v) information about profitability of one or more gaming devices;

(vi) information about players, including information about the gambling activity of players;

(vii) information about offers provided to players during play of one or more games;

(viii) indications (e.g., signals) from various parties;

(ix) information about a casino or other establishment;

(x) information about one or more games;

(xi) information about one or more providers of games;

(xii) time-related conditions;

(xiii) authorization codes; and

(xiv) random numbers.

Other appropriate categories or types of information will be recognized by one of ordinary skill in the art after reading the present application. The types of information described herein are categorized for illustrative purposes only. Note that some information consistent with one or more embodiments of the present invention may reasonably be considered as related to or falling within two, more than two, or none of the categories of information described herein. Also, although information may be described as being related to a single entity (e.g., a player, a gaming device) for illustrative purposes only, one skilled in the art will understand that similar information related to a plurality of such entities (e.g., an aggregate revenue generated on all gaming devices, an average per gaming device) may also be used in accordance with one or more embodiments of the present invention.

A measure of performance, as used herein unless expressly indicated otherwise, may refer to a measure of performance of a game and/or of a gaming device, and may include, but is not limited to, (i) one or more measures of usage of games and/or gaming devices; (ii) one or more measures of profitability of games and/or gaming devices, and/or (iii) variances in any such measures that may be correlated to the use or non-use of one or more games on a gaming device.

In some embodiments, a measure of performance may comprise an indication of a change in a particular measure (e.g., of usage, of profitability) related to a game (or to a gaming device). For example, a measure of performance of a game may be the determined increase in the number of players using a gaming device at which the game is enabled, or an increase in the average amount that players wager at a gaming device on which the game is enabled. In another example, an increase in the theoretical win per minute of a gaming device, during a period that started when a game was enabled at the gaming device, may be a useful indicator in determining whether the game should be enabled or disabled on the gaming device, as well as for determining whether the game should be enabled or disabled on other gaming devices. For example, a condition may be established that if the increase is greater than a predetermined value, then the game should be automatically enabled on other gaming devices of the same type.

Measures of usage, performance, and profitability are also convenient for determining payment due to providers of games.

Some examples of information that may facilitate the management of various games for use on one or more gaming devices (e.g., in determining whether a game should be enabled on a gaming device) include, but are not limited to:

(i) An amount of revenue generated while a game is played;

(ii) An average amount wagered by a player (or players) playing a game;

(iii) An average rate of play of a game;

(iv) An average session theoretical win when a player is playing a game;

(v) A number of customer service complaints relating to a game;

(vi) An average duration of a gaming session in which a player plays a game;

(vii) A number of machines at which a game is played;

(viii) A percentage amount of machines at which a game is played;

(ix) A number of times that a game is played (e.g., within a period of time);

(x) An average number of times that a game is played by a player;

(xi) A period of time that a game is played (e.g., in minutes or hours);

(xii) A period of time that one or more gaming devices are played;

(xiii) A percentage amount of all gaming devices that are gaming devices on which a game is played;

(xiv) Which gaming device(s) (e.g., types of gaming devices) a game is played on;

(xv) What types of players play a game (e.g., new players, old players, “high rollers”);

(xvi) Information about games that are enabled concurrently with at least one other game;

(xvii) A time of day when a game is played (e.g., during peak hours, during the middle of the night);

(xviii) A profit of a gaming device while a game was played;

(xix) An amount of revenue resulting from play of a game;

(xx) A profit during play of a game (e.g., profit earned from accepted offers during play of a game);

(xxi) An increase (or decrease) in payout percentage (e.g., at one or more gaming devices;

(xxii) An increase (or decrease) in theoretical win (e.g., at one or more gaming devices)

(xxiii) A value of a benefit (e.g., money) paid to a player (e.g., money paid to a player by sponsors, such as if a player performs one or more value-added activities);

(xxiv) An amount of revenue generated at one or more gaming devices near a gaming device at which a game is played (e.g., if a game makes play so entertaining that it makes players move to one area of the casino);

(xxv) A number or value of comps received by a player (e.g., playing a particular game);

(xxvi) A percentage of funds stored with a server (e.g., due to interest);

(xxvii) An increase or decrease in a player's rate of play (e.g., comparing play with a game enabled and play without the game enabled);

(xxviii) A number of offers accepted or rejected by a player during play of a game;

(xxix) A percentage of offers that are rejected/that are accepted during play of a game;

(xxx) An increase or decrease in the amount of coin-in by a player (e.g., comparing play with a particular game enabled and play without the game enabled);

(xxxi) An increase or decrease in the (average) session length of a player (e.g., comparing session length when a game is enabled and play when a game is not enabled);

(xxxii) An increase or decrease in the percentage of time a player spends gambling during a casino visit;

(xxxiii) Whether a player signs up for a player tracking card;

(xxxiv) A number of players who sign up for player tracking cards;

(xxxv) How often a game is played (e.g., whether the number of times a game is played on a gaming device (or gaming devices) each day is greater than a predetermined number of times);

(xxxvi) A period of time for which a game is played by a player (or players) (e.g., for determining whether the period of time that a player played a game was less than five minutes, or whether the average period of time that players play a game is less than two hours);

(xxxvii) What type(s) of gaming devices the game is played with (e.g., for determining whether the game is played on machines in the smoking section);

(xxxviii) What type(s) of players use the game (e.g., for determining whether a predetermined minimum number of novice players have played the game); and

(xxxix) A number of different players who have played the game (e.g., for determining whether a predetermined minimum number of unique players have played the game).

Other types of information useful in managing games will be recognized by one of ordinary skill in the art after reading the present application.

Although measures related to usage of a game (e.g., information related to behavior of players at a gaming device while a game was actually active or in use) are discussed frequently herein as useful measures of performance of a game, it will be understood that a useful measure of performance may be related to activity at a gaming device while a game is merely enabled for use on the gaming device, regardless of whether the game is ever selected or played by a player. For example, a player may be attracted to a gaming device at which a particular game is enabled for use (and may as a result spend longer playing the gaming device), simply because the particular game is available to the player, or may be offered to the player, even if the player does not use the game most of the time or even at all. In other words, some players may choose to play a gaming device at which particular games are enabled over another gaming device lacking the games, even if the player does not take advantage of the games.

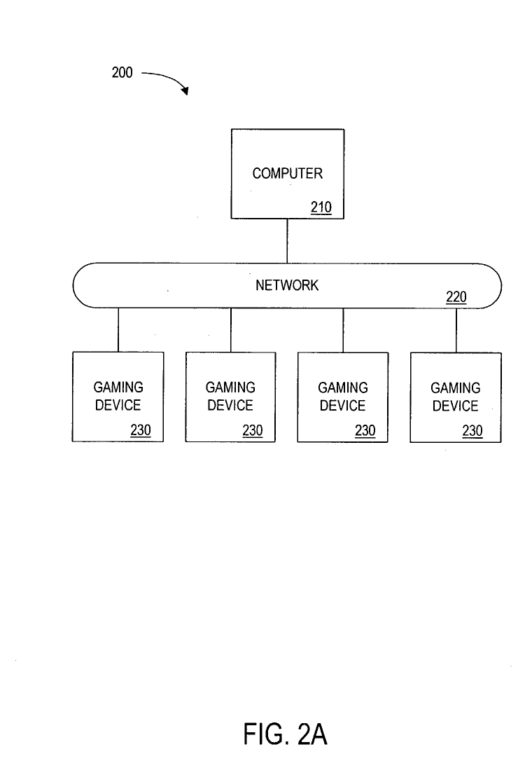

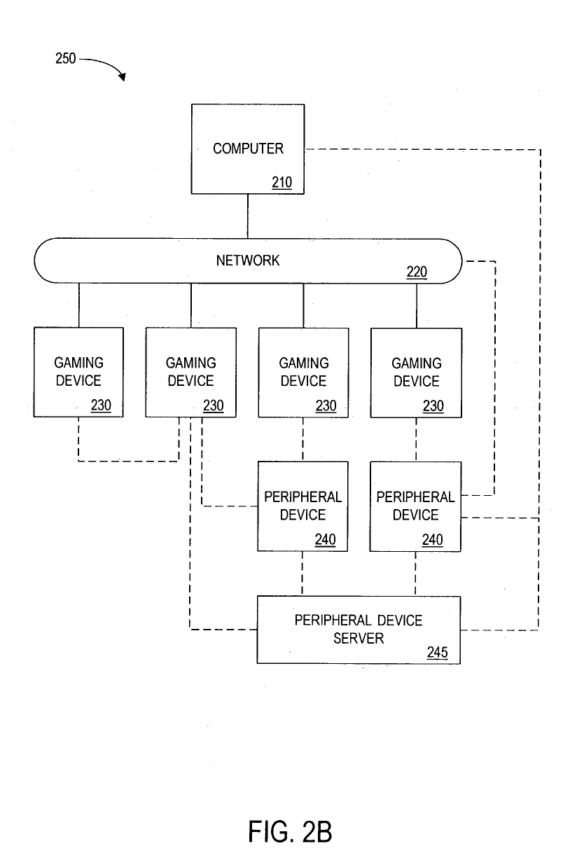

Referring now to FIG. 2A, a block diagram of a system 200 according to at least one embodiment of the present invention includes a computer 210 (e.g., a game terminal server of a casino) that is in communication, via a communications network 220, with one or more gaming devices 230 (e.g., slot machines, video poker machines). The computer 210 may communicate with the devices 230 directly or indirectly, via a wired or wireless medium such as the Internet, LAN, WAN or Ethernet, Token Ring, or via any appropriate communications means or combination of communications means. Each of the devices 230 may comprise computers, such as those based on the INTEL® PENTIUM® processor, that are adapted to communicate with the computer 210. Any number and type of devices 230 may be in communication with the computer 210.

Communication between the devices 230 and the computer 210, and among the devices 230, may be direct or indirect, such as over the Internet through a Web site maintained by computer 210 on a remote server or over an on-line data network including commercial on-line service providers, bulletin board systems and the like. In yet other embodiments, the devices 230 may communicate with one another and/or computer 210 over RF, cable TV, satellite links and the like.

Some, but not all, possible communication networks that may comprise network 220 or be otherwise part of system 200 include: a local area network (LAN), a wide area network (WAN), the Internet, a telephone line, a cable line, a radio channel, an optical communications line, a satellite communications link. Possible communications protocols that may be part of system 200 include: Ethernet (or IEEE 802.3), SAP, ATP, Bluetooth™, and TCP/IP. Communication may be encrypted to ensure privacy and prevent fraud in any of a variety of ways well known in the art.

Those skilled in the art will understand that devices in communication with each other need not be continually transmitting to each other. On the contrary, such devices need only transmit to each other as necessary, and may actually refrain from exchanging data most of the time. For example, a device in communication with another device via the Internet may not transmit data to the other device for weeks at a time.

In some embodiments, the computer 210 may not be necessary and/or preferred. For example, the present invention may, in one or more embodiments, be practiced on a stand-alone gaming device 230 and/or a gaming device 230 in communication only with one or more other gaming devices 230. In such an embodiment, any functions described as performed by the computer 210 or data described as stored on the computer 210 may instead be performed by or stored on one or more gaming devices 230.

Referring now to FIG. 2B, a block diagram of another system 250 according to at least one embodiment of the present invention includes a computer 210 (e.g., a game terminal server of a casino) that is in communication, via a communications network 220, with one or more gaming devices 230 (e.g., slot machines, video poker machines). A difference between system 200 (FIG. 2A) and system 250 (FIG. 2B) is that in system 250 at least one gaming device 230 is also in communication with one or more peripheral devices 240. A peripheral device 240 may, in turn, be in communication with a peripheral device server 245 and, in some embodiments, with computer 210. In one or more embodiments the peripheral device server 245 may be in communication with one or more gaming devices 240 and/or computer 210.

The computer 210 may communicate with the devices 230 and devices 240 directly or indirectly, via a wired or wireless medium such as the Internet, LAN, WAN or Ethernet, Token Ring, or via any appropriate communications means or combination of communications means. For example, the computer. 210 may communicate directly with one of the gaming devices 230 (e.g., via a LAN) and indirectly (e.g., via a gaming device 230) with a peripheral device 240. In another example, the computer 210 may communicate with one of the gaming devices 230 via a LAN and with another of the gaming devices 230 via the Internet (e.g., if the particular gaming device comprises a personal computer in communication with an online casino).

Each of the devices 230 and the devices 240 may comprise computers, such as those based on the INTEL® PENTIUM® processor, that are adapted to communicate with the computer 210. Further, each of the devices 230 may comprise a gaming device such as a mechanical or electronic slot machine, a video poker machine, a video blackjack machine, a video keno machine, a pachinko machine, a video roulette machine, and/or a lottery terminal. Further yet, each of the devices 240 may comprise an external or internal module associated with one or more of the gaming devices 230 that is capable of communicating with one or more of the gaming devices 230 and of directing the one or more gaming devices 230 to perform one or more functions. Any number of devices 230 may be in communication with the computer 210. Any number and type of peripheral devices 240 may be in communication with a gaming device 230, peripheral device server 245 and computer 210.

Communication between the devices 230 and the computer 210, between the devices 230 and devices 240, between peripheral device server 245 and the devices 240 and/or the devices 230, between the peripheral device server 245 and computer 210, among the devices 230, and among the devices 240 may be direct or indirect, such as over the Internet through a Web site maintained by computer 210 on a remote server or over an on-line data network including commercial on-line service providers, bulletin board systems and the like. In yet other embodiments, any and all of the devices of system 250 (i.e., the devices 230, the devices 240, the computer 210, and the peripheral device server 245) may communicate with one another over RF, cable TV, satellite links and the like.

Some, but not all, possible communication networks that may comprise network 220 or otherwise be part of system 250 include: a local area network (LAN), a wide area network (WAN), the Internet, a telephone line, a cable line, a radio channel, an optical communications line, a satellite communications link. Possible communications protocols that may be part of system 250 include: Ethernet (or IEEE 802.3), SAP, ATP, Bluetooth™, and TCP/IP. Communication may be encrypted to ensure privacy and prevent fraud in any of a variety of ways well known in the art.

In some embodiments, the computer 210 may not be necessary and/or preferred. For example, the present invention may, in one or more embodiments, be practiced on a stand-alone gaming device 230, one or more gaming devices in communication with one or more peripheral devices 240, one or more gaming devices in communication with peripheral device server 245, one or more peripheral devices 240 in communication with peripheral device server 245, and/or a gaming device 230 in communication only with one or more other gaming devices 230. In such an embodiment, any functions described as performed by the computer 210 or data described as stored in a memory of the computer 210 may instead be performed by or stored on one or more gaming devices 230, one or more peripheral devices 240, and/or peripheral device server 245.

Similarly, peripheral device server 245 may not be desired and/or needed in some embodiments of the present invention. In embodiments that do not involve peripheral device server 245, any or all of the functions described herein as being performed by peripheral device server 245 may instead be performed by computer 210, one or more gaming devices 230, one or more peripheral devices 240, or a combination thereof. Similarly, in embodiments that do not involve peripheral device server 245 any data described herein as being stored in a memory of peripheral device server 245 may instead be stored in a memory of computer 210, one or more gaming devices 230, one or more peripheral devices 240, or a combination thereof.

Any or all of the gaming devices 230 may, respectively, include or be in communication with a peripheral device 240. A peripheral device 240 may be a device that receives information from (and/or transmits information to) one or more gaming devices 230. For example, a peripheral device 240 may be operable to receive information about games being played on a gaming device 230, such as the initiation of a game and/or a random number that has been generated for a game, and/or may be operable to receive information about games enabled on the gaming device 230.

In one or more embodiments, one or more such peripheral devices 240 may be in communication with a peripheral device server 245. This allows the peripheral device server 245 to receive information regarding a plurality of games being played on a plurality of gaming devices 230. The peripheral device server 245, in turn, may be in communication with the computer 210. It should be understood that any functions described herein as performed by a peripheral device 240 may also or instead be performed by the peripheral device server 245. Similarly, any data described herein as being stored on or accessed by a peripheral device 240 may also or instead be stored on or accessed by the peripheral device server 245.

A peripheral device 240 may be operable to access a database (e.g., of peripheral device server 245) to provide benefits (e.g., cashless gaming receipts) based on, for example, a game enabled at a gaming device 230.

The peripheral device server 245 may also monitor player gambling history over time by associating gambling behavior with player identifiers, such as player tracking card numbers. For example, in embodiments wherein a player selects which game is to be active, the peripheral device server 245 may track which game the player has previously selected and subsequently use that information to present other offers for games to the player and/or to output other information to the player. Further, information about the player obtained or accessed by peripheral device server 245 may be analyzed, e.g., to identify those players that a particular gaming machine owner, operator, or manufacturer finds most desirable. Based upon desired objectives, the peripheral device server 245 may direct the appropriate peripheral device 240 to issue customized messages to specific players that are relevant to their gambling behaviors.

Information received by a peripheral device 240 from a gaming device 230 may include gambling data such as number of games initiated per unit of time, outcomes displayed for games initiated, payouts corresponding to outcomes displayed, a credit meter balance of the gaming device, and/or data associated with the player currently playing the gaming device 230.

The functions described herein as being performed by a peripheral device server 245 and/or a peripheral device 240 may, in one or more embodiments, be performed by the computer 210 (in lieu of or in conjunction with being performed by a peripheral device server 245 and/or a peripheral device 240). Such functions may be performed by computer 210 in either system 200 (FIG. 2A) or system 250 (FIG. 2B).

In one or more embodiments, a peripheral device 240 may be useful for implementing the embodiments of the present invention into the operation of a conventional gaming device. For example, in order to avoid or minimize the necessity of modifying or replacing a program already stored in a memory of a conventional gaming device, an external or internal module that comprises a peripheral device 240 may be inserted in or associated with the gaming device.

Thus, for example, a peripheral device 240 may be utilized to monitor play of the gaming device and enhance or otherwise affect play in accordance with one or more active games. In such embodiments the gaming device 230 with which the peripheral device 240 is in communication with may continue to operate conventionally. In such embodiments, for example, if a game includes the displaying of video content, operation of the gaming device 230 may continue conventionally. The peripheral device 240, however, may output one or more video displays (e.g., in coordination with various game events). The peripheral device 240 may also output messages to the player (e.g., “Would you like to play “All-Star Poker?”). The peripheral device 240 may also provide benefits to a player (e.g., coins, tokens, electronic credits, paper receipts exchangeable for cash, services, and/or merchandise).

Accordingly, a peripheral device 240 may include (i) a communications port (e.g., for communicating with one or more gaming devices 230, peripheral device server 245, another peripheral device 240, and/or computer 210); (ii) a display (e.g., for displaying messages and/or outcomes), (iii) another output means (e.g., a speaker, light, or motion device to communicate with a player), and/or (iv) a benefit providing means (e.g., a printer and paper dispensing means, a credit meter, and/or a hopper and hopper controller).

In one or more embodiments, the peripheral device may not output outcomes and/or messages to a player but may instead direct the processor of a gaming device to perform such functions. For example, a program stored in a memory of peripheral device 240 may cause a processor of a gaming device to perform certain functions. For example, a program stored in a memory of peripheral device 240 may cause a processor of a gaming device to provide an enabled game.

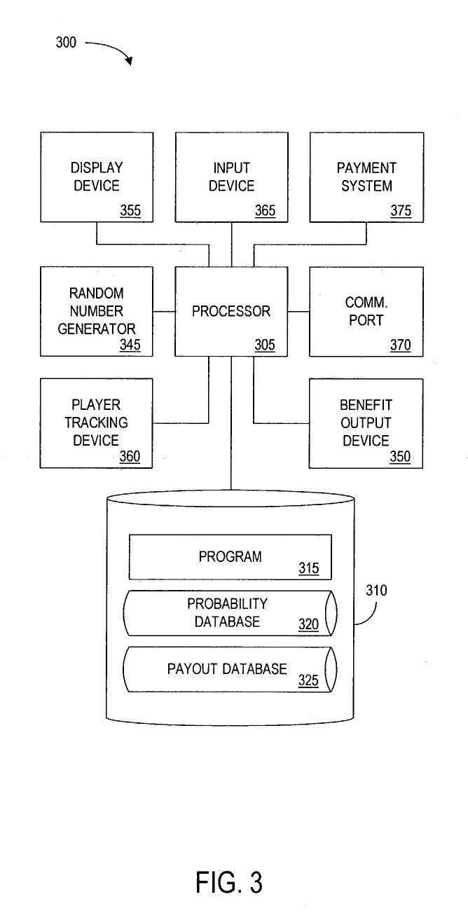

Referring now to FIG. 3, illustrated therein is a block diagram of an embodiment 300 of a gaming device. The gaming device 300 may be implemented as a system controller, a dedicated hardware circuit, an appropriately programmed general-purpose computer, or any other equivalent electronic, mechanical or electromechanical device. The gaming device 300 may comprise, for example, a slot machine, a video poker terminal, a video blackjack terminal, a video keno terminal, a video lottery terminal, a pachinko machine or a table-top game. In various embodiments, a gaming device may comprise, for example, a personal computer (e.g., which communicates with an online casino Web site), a telephone (e.g., to communicate with an automated sports book that provides gaming services), or a portable handheld gaming device (e.g., a personal digital assistant or NINTENDO® GAMEBOY®). The gaming device 300 may comprise any or all of the gaming devices 230 of system 200 (FIG. 2A) or system 250 (FIG. 2B). In some embodiments, a user device such as a PDA or cell phone may be used in place of, or in addition to, some or all of the gaming device 300 components depicted in FIG. 3. Further, a gaming device may comprise a personal computer or other device operable to communicate with an online casino and facilitate game play at the online casino. In one or more embodiments, the gaming device 300 may comprise a computing device operable to execute software that simulates play of a reeled slot machine game, video poker game, video blackjack game, video keno game, video roulette game, lottery game and/or other enabled games.

The gaming device 300 comprises a processor 305, such as one or more INTEL® PENTIUM® processors. The processor 305 is in communication with a memory 310 and a communications port 370 (e.g., for communicating with one or more other devices). The memory 310 may comprise an appropriate combination of magnetic, optical and/or semiconductor memory, and may include, for example, Random Access Memory (RAM), Read-Only Memory (ROM), a compact disc and/or a hard disk. The memory 310 may comprise or include any type of computer-readable medium. The processor 305 and the memory 310 may each be, for example: (i) located entirely within a single computer or other device; or (ii) connected to each other by a remote communication medium, such as a serial port cable, telephone line or radio frequency transceiver. In one embodiment, the gaming device 300 may comprise one or more devices that are connected to a remote server computer for maintaining databases.

The memory 310 stores a program 315 for controlling the processor 305. The processor 305 performs instructions of the program 315, and thereby operates in accordance with the present invention, and particularly in accordance with the methods described in detail herein. The program 315 may be stored in a compressed, uncompiled and/or encrypted format. The program 315 furthermore includes program elements that may be necessary, such as an operating system, a database management system and “device drivers” for allowing the processor 305 to interface with computer peripheral devices. Appropriate program elements are known to those skilled in the art, and need not be described in detail herein.

The term “computer-readable medium” as used herein refers to any medium that participates in providing instructions to processor 305 (or any other processor of a device described herein) for execution. Such a medium may take many forms, including but not limited to, non-volatile media, volatile media, and transmission media. Non-volatile media include, for example, optical or magnetic disks, such as memory 310. Volatile media include dynamic random access memory (DRAM), which typically constitutes the main memory. Transmission media include coaxial cables, copper wire and fiber optics, including the wires that comprise a system bus coupled to the processor 305. Transmission media can also take the form of acoustic or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying one or more sequences of one or more instructions to processor 305 (or any other processor of a device described herein) for execution. For example, the instructions may initially be borne on a magnetic disk of a remote computer. The remote computer can load the instructions into its dynamic memory and send the instructions over a telephone line using a modem. A modem local to a gaming device 300 (or, e.g., a computer 210) can receive the data on the telephone line and use an infrared transmitter to convert the data to an infrared signal. An infrared detector can receive the data carried in the infrared signal and place the data on a system bus for processor 305. The system bus carries the data to main memory, from which processor 200 retrieves and executes the instructions. The instructions received by main memory may optionally be stored in memory 310 either before or after execution by processor 305. In addition, instructions may be received via communication port 370 as electrical, electromagnetic or optical signals, which are exemplary forms of carrier waves that carry data streams representing various types of information. Thus, the gaming device 300 may obtain instructions in the form of a carrier wave.

According to an embodiment of the present invention, the instructions of the program 315 may be read into a main memory from another computer-readable medium, such from a ROM to RAM. Execution of sequences of the instructions in program 315 causes processor 305 to perform the process steps described herein. In alternate embodiments, hard-wired circuitry may be used in place of, or in combination with, software instructions for implementation of the processes of the present invention. Thus, embodiments of the present invention are not limited to any specific combination of hardware and software. As discussed with respect to system 250 of FIG. 2B, execution of sequences of the instructions in a program of a peripheral device 240 in communication with gaming device 300 may also cause processor 305 to perform some of the process steps described herein.

The memory 310 also stores a plurality of databases, including a probability database 320, and a payout database 325. Note, although these databases are described as being stored in a gaming device, in other embodiments of the present invention some or all of these databases may be partially or wholly stored in another device, such as one or more of the peripheral devices 240, the peripheral device server 245 and/or the computer 210. Further, some or all of the data described as being stored in the databases 320-335 may be partially or wholly stored (in addition to or in lieu of being stored in the memory 310 of the gaming device 300) in a memory of one or more other devices, such as one or more of the peripheral devices 240, another gaming device 230, the peripheral device server 245 and/or the computer 210.

The databases 320 and 325 are well known in the art, and need not be described in detail herein. Also, some enabled games may not require probability database 320 and/or payout database 325.

The processor 305 is also operable to communicate with a random number generator 345, which may be a component of gaming device 300. The random number generator, in accordance with at least one embodiment of the present invention, may generate data representing random or pseudo-random values (referred to as “random numbers” herein). The random number generator may generate a random number every predetermined unit of time (e.g., every second) or in response to an initiation of a game on the gaming device. In the former embodiment, the generated random numbers may be used as they are generated (e.g., the random number generated at substantially the time of game initiation is used for that game) and/or stored for future use.

A random number generator, as used herein, may be embodied as a processor separate from but working in cooperation with processor 305. Alternatively, random number generator 345 may be embodied as an algorithm, program component, or software stored in the memory of gaming device 300 and used to generate a random number.

Note that, although the generation or obtainment of a random number is described herein as involving a random number generator of a gaming device, other methods of determining a random number may be employed. For example, a gaming device owner or operator may obtain sets of random numbers that have been generated by another entity. HOTBITS™, for example, is a service that provides random numbers that have been generated by timing successive pairs of radioactive decays detected by a Geiger-Muller tube interfaced to a computer. A blower mechanism that uses physical balls with numbers thereon may be used to determine a random number by randomly selecting one of the balls and determining the number thereof.

The processor 305 is also operable to communicate with a benefit output device 350, which may be a component of gaming device 300. The benefit output device 350 may comprise one or more devices for outputting a benefit to a player of the gaming device 300. For example, in one embodiment the gaming device 300 may provide coins and/or tokens as a benefit. In such an embodiment the benefit output device 350 may comprise a hopper and hopper controller, for dispensing coins and/or tokens into a coin tray of the gaming device 300. In another example, the gaming device 300 may provide a receipt or other document on which there is printed an indication of a benefit (e.g., a cashless gaming receipt that has printed thereon a monetary value, which is redeemable for cash in the amount of the monetary value). In such an embodiment the benefit output device 350 may comprise a printing and document dispensing mechanism. In yet another example, the gaming device 300 may provide electronic credits as a benefit (which, e.g., may be subsequently converted to coins and/or tokens and dispensed from a hopper into a coin tray). In such an embodiment the benefit output device 350 may comprise a credit meter balance and/or a processor that manages the amount of electronic credits that is indicated on a display of a credit meter balance. The processor may be the processor 305 or another processor. In yet another example, the gaming device 300 may credit a monetary amount to a financial account associated with a player as a benefit provided to a player. The financial account may be, for example, a credit card account, a debit account, a charge account, a checking account, or a casino account. In such an embodiment the benefit output device may comprise a device for communicating with a server on which the financial account is maintained.

Note that, in one or more embodiments, the gaming device 300 may include more than one benefit output device 350 even though only one benefit output device is illustrated in FIG. 3. For example, the gaming device 300 may include both a hopper and hopper controller combination and a credit meter balance. Such a gaming device may be operable to provide more than one type of benefit to a player of the gaming device. A single benefit output device 350 may be operable to output more than one type of benefit. For example, a benefit output device 350 may be operable to increase the balance of credits in a credit meter and communicate with a remote device in order to increase the balance of a financial account associated with a player.

The processor 305 is also operable to communicate with a display device 355, which may be a component of gaming device 300. The display device 355 may comprise, for example, one or more display screens or areas for outputting information related to game play on the gaming device, such as a cathode ray tube (CRT) monitor, liquid crystal display (LCD) screen, or light emitting diode (LED) screen.

In one or more embodiments, a gaming device may comprise more than one display device. For example, a gaming device may comprise an LCD display for displaying electronic reels and a display area that displays rotating mechanical reels.

The processor 305 may also be in communication with one or more other devices besides the display device 355, for outputting information (e.g., to a player or another device). Such other one or more output devices may also be components of gaming device 300. Such other one or more output devices may comprise, for example, an audio speaker (e.g., for outputting an offer for a game or information related thereto, in addition to or in lieu of such information being output via a display device 355), an infra-red transmitter, a radio transmitter, an electric motor, a printer (e.g., such as for printing cashless gaming vouchers), a coupon or product dispenser, an infra-red port (e.g., for communicating with a second gaming device or a portable device of a player), a Braille computer monitor, and a coin or bill dispenser. For gaming devices, common output devices include, but are not limited to, a cathode ray tube (CRT) monitor on a video poker machine, a bell on a gaming device (e.g., rings when a player wins), an LED display of a player's credit balance on a gaming device, and an LCD display of a personal digital assistant (PDA).

The display device 355 may comprise, for example, one or more display areas. For example, one of the display areas may display outcomes of games played on the gaming device (e.g., electronic reels of a gaming device). Another of the display areas may display rules for playing a game of the gaming device. Yet another of the display areas may display the benefits obtainable by playing a game of the gaming device (e.g., in the form of a payout table). In one or more embodiments, the gaming device 300 may include more than one display device, one or more other output devices, or a combination thereof (e.g., two display devices and two audio speakers).

The processor 305 is also in communication with an input device 365, which is a device that is capable of receiving an input (e.g., from a player or another device) and which may be a component of gaming device 300. An input device may communicate with or be part of another device (e.g. a server, a gaming device, etc.). Some examples of input devices include: a bar-code scanner, a magnetic stripe reader, a computer keyboard or keypad, a button, a handle, a keypad, a touch-screen, a microphone, an infrared sensor, a voice recognition module, a coin or bill acceptor, a sonic ranger, a computer port, a video camera, a motion detector, a digital camera, a network card, a universal serial bus (USB) port, a GPS receiver, a radio frequency identification (RFID) receiver, an RF receiver, a thermometer, a pressure sensor, an infrared port (e.g., for receiving communications from with a second gaming device or a another device such as a smart card or PDA of a player), and a weight scale. For gaming devices, common input devices include a button or touch screen on a video poker machine, a lever or handle connected to the gaming device, a magnetic stripe reader to read a player tracking card inserted into a gaming device, a touch screen for input of player selections during game play, and a coin and bill acceptor.

The processor 305 is also in communication with a payment system 375, which may be a component of gaming device 300. The payment system 375 is a device capable of accepting payment from a player (e.g., a bet or initiation of a balance) and/or providing payment to a player (e.g., a payout). Payment is not limited to money, but may also include other types of consideration, including products, services, and alternate currencies.

Exemplary methods of accepting payment by the payment system 375 include (i) receiving hard currency (i.e., coins or bills), and accordingly the payment system 375 may comprise a coin or bill acceptor; (ii) receiving an alternate currency (e.g., a paper cashless gaming voucher, a coupon, a non-negotiable token), and accordingly the payment system 375 may comprise a bar code reader or other sensing means; (iii) receiving a payment identifier (e.g., a credit card number, a debit card number, a player tracking card number) and debiting the account identified by the payment identifier; and (iv) determining that a player has performed a value-added activity.

In one embodiment, a player may operate a plurality of gaming devices. For example, a player may simultaneously play two side-by-side gaming devices, a player may play one gaming device (e.g. a gaming device) and then continue his gaming session at another gaming device (e.g. a video poker machine), and a player may remotely operate a gaming device, possibly by using a telephone, PDA or other device (i) to transmit commands (directly or indirectly) to the gaming device, such as wager amounts and commands to select certain cards; and/or (ii) to receive output (directly or indirectly) from the gaming device.

In one embodiment, a gaming device may allow a player to play a game of skill rather than a game of chance. Such an embodiment may be more appealing to certain players or may be permitted in areas where it is illegal to gamble on games of chance.

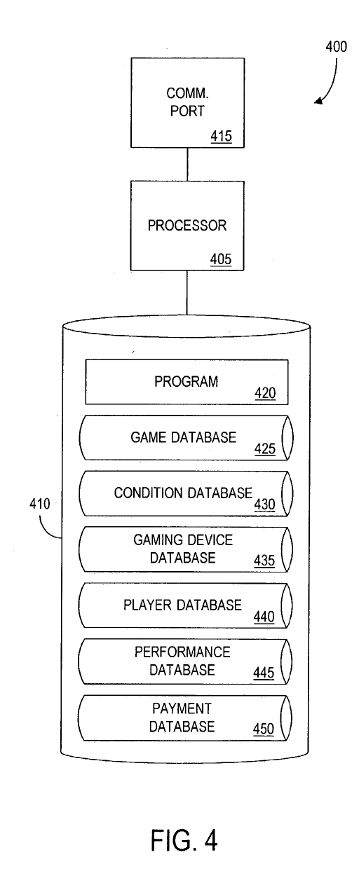

Referring now to FIG. 4, illustrated therein is a block diagram of an embodiment 400 of computer 210 (FIG. 2A and FIG. 2B). The computer 400 may be implemented as a system controller, a dedicated hardware circuit, an appropriately programmed general-purpose computer, or any other equivalent electronic, mechanical or electromechanical device. The computer 400 may comprise, for example, a server computer operable to communicate with one or more client devices, such as gaming devices 230. The computer 400 is operative to manage the system 200 and the system 250 and execute the methods of the present invention.

In operation, the computer 400 may function under the control of a casino, a merchant, or other entity that may also control use of the gaming devices 230, peripheral devices 240, and/or peripheral device server 245. For example, the computer 400 may be a game terminal server in a casino. In some embodiments, the computer 400 and game terminal server may be different devices. In some embodiments, the computer 400 may comprise more than one computer operating together. In some embodiments, the computer 400 and peripheral device server 245 may be the same device.

The computer 400 comprises a processor 405, such as one or more INTEL® PENTIUM® processors. The processor 405 is in communication with a memory 410 and a communications port 415 (e.g., for communicating with one or more other devices). The memory 410 may comprise an appropriate combination of magnetic, optical and/or semiconductor memory, and may include, for example, Random Access Memory (RAM), Read-Only Memory (ROM), a compact disc and/or a hard disk. The processor 405 and the memory 410 may each be, for example: (i) located entirely within a single computer or other device; or (ii) connected to each other by a remote communication medium, such as a serial port cable, telephone line or radio frequency transceiver. In one embodiment, the computer 400 may comprise one or more devices that are connected to a remote server computer for maintaining databases.

The memory 410 stores a program 420 for controlling the processor 405. The processor 405 performs instructions of the program 420, and thereby operates in accordance with the present invention, and particularly in accordance with the methods described in detail herein. The program 420 may be stored in a compressed, uncompiled and/or encrypted format. The program 420 furthermore includes program elements that may be necessary, such as an operating system, a database management system and “device drivers” for allowing the processor 405 to interface with computer peripheral devices. Appropriate program elements are known to those skilled in the art, and need not be described in detail herein.

According to an embodiment of the present invention, the instructions of the program 420 may be read into a main memory from another computer-readable medium, such from a ROM to RAM. Execution of sequences of the instructions in program 420 causes processor 405 to perform the process steps described herein. In alternate embodiments, hard-wired circuitry may be used in place of, or in combination with, software instructions for implementation of the processes of the present invention. Thus, embodiments of the present invention are not limited to any specific combination of hardware and software.

The memory 410 also stores a plurality of databases, including a game database 425, a condition database 430, a gaming device database 435, a player database 440, a performance database 445, and a payment database 450. Each of these databases is described in detail below and example structures are depicted with sample entries in the accompanying figures. As will be understood by those skilled in the art, the schematic illustrations and accompanying descriptions of the sample databases presented herein are exemplary arrangements for stored representations of information. Any number of other arrangements may be employed besides those suggested by the tables shown. For example, even though six separate databases are illustrated, the invention could be practiced effectively using any number of more or fewer functionally equivalent databases. Similarly, the illustrated entries of the databases represent exemplary information only; those skilled in the art will understand that the number and content of the entries can be different from those illustrated herein. Further, despite the depiction of the databases as tables, an object-based model could be used to store and manipulate the data types of the present invention and likewise, object methods or behaviors can be used to implement the processes of the present invention.

Note that, although these databases are described as being stored in a gaming device, in other embodiments of the present invention some or all of these databases may be partially or wholly stored in another device, such as one or more of the peripheral devices 240, the peripheral device server 245, one or more of the gaming devices 230, a game terminal server (if different from the computer 210), another device, or a combination thereof. Further, some or all of the data described as being stored in the databases 425, 430, 435, 440, 445, and 450 may be partially or wholly stored (in addition to or in lieu of being stored in the memory 410 of the computer 400) in a memory of one or more other devices, such as one or more of the peripheral devices 240, one or more of the gaming devices 230, the peripheral device server 245 and/or a game terminal server (if different from computer 210).

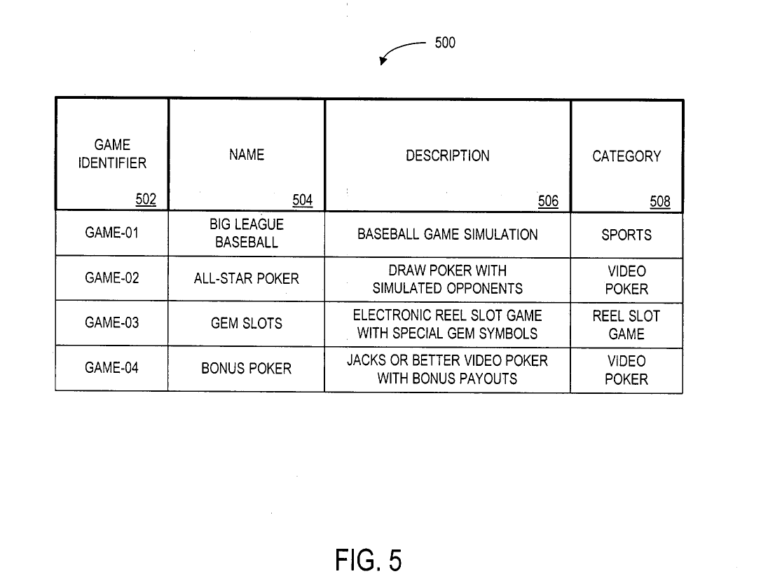

Referring now to FIG. 5, an exemplary tabular representation 500 illustrates one embodiment of the game database 425 (FIG. 4) that may be stored in the computer 400. The tabular representation 500 of the game database includes a number of example records or entries, each defining a game that may be enabled on a gaming device 300 by the computer 400 (or the gaming device 300). Those skilled in the art will understand that the game database may include any number of entries.

The tabular representation 500 also defines fields for each of the entries or records. The fields specify: (i) a game identifier 502 that uniquely identifies a particular game, (ii) a name 504 that includes a name of the particular game, (iii) a description 506 that contains a description (e.g., a text description) of the game, and (iv) a category 508 that stores an indication of a group or category of games with which the game may be identified.

The name 504, the category 508, and/or the description 506 may be used in outputting information and messages to a player (e.g., at display device 355 of the gaming device 300). For example, a player may receive a displayed offer: “Click here to play All-Star Poker!”. In another example, the player's selection of a game from a list of displayed games may cause the description 506 to be displayed in a display area of a gaming device.

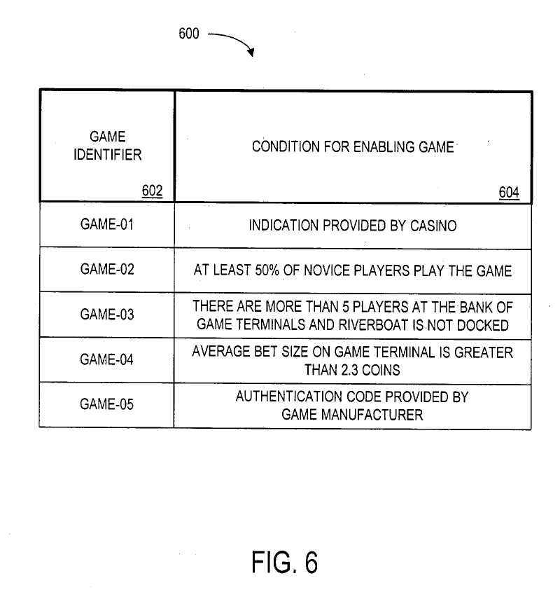

Referring now to FIG. 6, an exemplary tabular representation 600 illustrates one embodiment of the condition database 430 (FIG. 4) that may be stored in the computer 400. The tabular representation 600 of the condition database includes a number of example records or entries, each defining a condition that may used, for example, for determining whether a game should be enabled (or disabled) on a gaming device 300 by the computer 400 (or the gaming device 300). Those skilled in the art will understand that the condition database may include any number of entries.

The tabular representation 600 also defines fields for each of the entries or records. The fields specify: (i) a game identifier 602 that identifies a particular game, and (ii) a condition for enabling game 604 that includes an indication of one or more requirements that must be satisfied in order to enable (or to keep enabled) the particular game.

As discussed herein, a condition for enabling game 604 may correspond to one or more requirements for enabling a game (and/or for keeping an enabled game enabled). A condition may alternatively correspond to one or more requirements for disabling a game (and/or for keeping the game disabled). Those skilled in the art will readily understand that a condition described as a condition for enabling a game may suggest a condition for disabling a game, and vice versa. For example, a condition that no more than fifty players can be playing a particular type of game terminal in order for a particular game to be enabled may also suggest a condition that the game is to be disabled if the number of players exceeds fifty.

In some embodiments, however, a condition for disabling or enabling a game may not necessarily suggest its opposite. For example, a described condition may indicate that a disabled game should be enabled if ten or more players are playing game terminals in a particular section of a casino. However, the game, once enabled, may or may not be disabled if the number of players playing falls below ten, for example.

Various types of information and factors on which conditions may be based are described herein, and other criteria and requirements will be readily understood by one skilled in the art in light of the present disclosure. Some examples of conditions include, but are not limited to:

(i) Whether an amount of revenue generated at a gaming device while a game is being used (e.g., an amount of coin-in and/or transaction amounts received from players in association with offers for products/services and other transactions at the gaming device) exceeds a predetermined minimum threshold;

(ii) Whether an average amount wagered by a player (or players) while a game is in use is greater than a historical average wager amount of the player;

(iii) An identity of a player operating the gaming device (e.g., some games may be available only to certain players, or only to players who use player tracking cards);

(iv) Past gambling activity of a player (e.g., whether the year-to-date coin-in by a player is less than a predetermined threshold);

(v) Current gambling activity (e.g., activity during a current session, or during a current trip to a casino) of a player (e.g., whether a current credit balance is less than a predetermined maximum amount, or whether an average rate of play during a current gaming session is greater than a predetermined threshold for enabling the game);

(vi) Anticipated future gambling activity of a player (e.g., whether a particular player (or players) is likely to stop gambling within the next ten minutes);

(vii) A preference of one or more players (e.g., whether a majority of players prefer a particular game, or whether a particular player has previously indicated a preference for the game);

(viii) A game that a player is currently playing (e.g., a slot machine game may be enabled if the player is currently playing another slot machine game);

(ix) A type of gaming device a player is currently playing (e.g., a game may be enabled for game terminals having a second display device);

(x) A location of the gaming device (e.g., a game may be enabled if the gaming device is near a door of a casino floor, but may not be enabled if the gaming device is near a poker room);

(xi) A manufacturer that produces a gaming device (e.g., a game may only be enabled at the gaming device if the gaming device is produced by a specific manufacturer); and

(xii) A developer, licensor, vendor, or other provider of a game (e.g., a game may only be enabled on gaming devices whose manufacturers have agreements with the provider of the game).

In some embodiments, the predetermined condition may be based on the time of day. For example, a game may be disabled between the hours of 8 p.m. and 11 p.m. (typically peak hours for gambling), because the operator of the slot machine is aware that players tend to play other games during these hours anyway.

Examples of time-related predetermined conditions that may need to be satisfied before a game is enabled on a gaming device include, but are not limited to:

(i) A period of time since an event (e.g., the game may be automatically disabled after a certain period of time after the game is initially enabled, after the game is first played, after the game is played a predetermined number of times, etc.); and

(ii) A time of day (e.g., the game may be disabled during particular times of the day).

Other appropriate time-related predetermined conditions will be recognized by one of ordinary skill in the art after reading the present application. Examples of predetermined conditions related to indications from parties that may need to be satisfied before a game is enabled on the gaming device include, but are not limited to:

(i) Whether a signal was provided, by or on behalf of a casino or other operator of the gaming device, indicating that the game should be enabled (e.g., a signal received from a casino employee observing a player becoming bored and/or discouraged in playing the gaming device);

(ii) Whether a signal was provided, by or on behalf of a regulatory group (e.g., a state, federal, or local government agency for regulating gambling activities), indicating that the game can be enabled (e.g., a signal received from a state gaming commission indicating that the game meets regulatory approval); and

(iii) Whether a signal was provided, by or on behalf of a provider of the game (e.g., a game manufacturer, a patent holder), indicating that the game can be enabled.

Other appropriate predetermined conditions related to indications received from or otherwise provided by any of various parties will be recognized by one of ordinary skill in the art after reading the present application. Note that indications such as those discussed herein may be provided in a variety of different ways, including, but not limited to: (i) using an input device of a server computer (e.g., a keyboard); (ii) using an input device of a gaming device (e.g., a touch screen); and (iii) using a peripheral device (described in further detail herein) in communication with a server computer and/or a gaming device.

In some embodiments, the provided indication from a party may comprise an authorization code, as discussed further herein. Examples of predetermined conditions related to authorization codes, that may need to be satisfied before a game is enabled on the gaming device include, but are not limited to:

(i) Whether at least one authorization code has been provided;

(ii) A period of time since at least one authorization code was provided (e.g., thirty days ago); and

(iii) A type of authorization code that has been provided (e.g., different authorization codes may enable the same game in different ways, such as for different periods of time).

Other appropriate predetermined conditions related to authorization codes will be recognized by one of ordinary skill in the art after reading the present application. Examples of predetermined conditions related to information about a casino that may need to be satisfied before a game is enabled on the gaming device include, but are not limited to:

(i) What casino operates a gaming device (e.g., a game may be enabled at a first casino but is to be disabled at a second casino, even if the casinos are commonly owned or operated and may have access to the same games);

(ii) A location or jurisdiction of a casino (e.g., a game may be disabled within a first geographic region, such as the state of Nevada, but enabled within a second geographic region, such as an American Indian reservation in the state of Arizona); and

(iii) A measure of usage of gaming devices at a casino (e.g., a second video poker game need not be enabled if more than 90% of game terminals offering a first video poker game are in use, as the clear demand for the game terminals indicates that there is no need to entice additional players by enabling the second video poker game).

Other appropriate predetermined conditions related to information about a casino will be recognized by one of ordinary skill in the art after reading the present application.

Another example of a predetermined condition comprises a minimum number of games played by a player on a gaming device. For example, it may be determined that it is desirable that a player making one hundred wagers on a gaming device should be rewarded by enabling a particular game on the gaming device.

In another example, it may be determined whether an outcome determined for a player playing a game at the determined gaming device satisfies a predetermined condition for enabling a second game. For instance, a gaming device may determine an outcome in a manner well known in the art. An outcome, as used herein, comprises at least one indicia that is utilized to inform a player of whether a benefit (e.g., a payout) has been won by the player as a result of playing a game. In a reeled slot machine game, for example, a set of symbols displayed along a payline comprises an outcome of a game. Some of the possible combinations of symbols obtainable in the reeled slot machine game correspond to a payout. Thus, a player is informed of whether he has won a payout by displaying a set of symbols along the payline. If the set of symbols along the payline correspond to a payout (e.g., as displayed on a payout table of the gaming device), then the player is informed that he has won the corresponding payout once the set of symbols is displayed along the payline. In a video poker game, as another example, the set of cards comprising the final hand comprises the outcome of a game.

The above examples of predetermined conditions have been provided for purposes of illustrating various embodiments consistent with the process 100D (FIG. 1D), and with some other methods for determining whether a game should be enabled or disabled on a gaming device. Other types of predetermined conditions and types of information on which such conditions may be based are described herein.

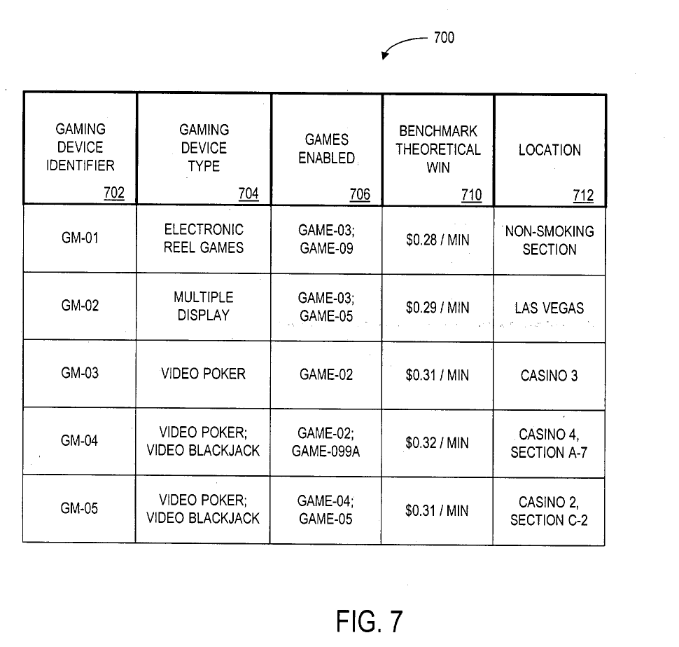

Referring now to FIG. 7, an exemplary tabular representation 700 illustrates one embodiment of the gaming device database 435 (FIG. 4) that may be stored in the computer 400. The tabular representation 700 of the gaming device database includes a number of example records or entries, each defining a gaming device that may be in communication (e.g., over a LAN or WAN) with computer 400. Those skilled in the art will understand that the gaming device database may include any number of entries.

The tabular representation 700 also defines fields for each of the entries or records. The fields specify: (i) a gaming device identifier 702 that uniquely identifies a particular gaming device (e.g., uniquely identifies a particular slot machine on a casino floor or a PC communicating with an online casino), (ii) a gaming device type 704 that stores a description or designation of the type of gaming device, (iii) a games enabled 706 that stores an indication or identifier of one or more games currently enabled on the gaming device, (iv) a benchmark theoretical win 710 that indicates a theoretical win for the gaming device (e.g., a historical theoretical win), and (v) a location 712 that stores an indication of the physical location of the particular gaming device.

The gaming device database may be used by computer 400, for example, to communicate with one or more gaming devices and to identify a gaming device that data is being transmitted to or received from. For example, the computer 400 may instruct a gaming device as to which games should be enabled and/or made active at the gaming device, transmit a random number to the gaming device, transmit an indication of a game for use by the gaming device, update information in one or more databases of the gaming device, and receive information associated with a player of the gaming device (e.g., a player identifier, player preferences, an indication of wagers placed or number of games played by a player, an indication of duration of play by a player at the gaming device, etc.). Some of this information may be stored in association with the gaming device. For example, the gaming device database may store an indication of the last time that a game was played on a particular gaming device.

The gaming device type 704 stores an indication of what types of games are available on the particular gaming device. Such information may be used, for example, to determine whether to enable a game on a gaming device. For example, in one embodiment it may be desirable that a particular game is not made available for use at game terminals in a particular section of a casino during particular times of day. Accordingly, the computer 400 may consider where a gaming device is located and the time of day in determining whether a game should be enabled on the gaming device.

The games enabled 706 stores an indication of what games are currently enabled for use on the particular gaming device. Such information may be used, for example, to determine whether to enable a particular game on a gaming device. For example, in one embodiment it may be desirable that a first game is not enabled if a second game is already enabled on the particular gaming device. For instance, a rule or condition may specify that the first game should only be enabled if the second game is not enabled on the gaming device. Further, such information may be used, for example, to track the usage of different games.

The benchmark theoretical win 710 stores an indication of a theoretical win of the gaming device that may be used, for example, as the basis for determining whether one or more games can be correlated to an effect on the theoretical win of a particular gaming device. For example, benchmark theoretical win 710 may be a value determined with respect to a particular period of time, such as a period of time preceding when a particular game was first enabled on the gaming device. A second theoretical win may be calculated for a period during which the game has been enabled. Thus, any difference between the benchmark and the theoretical win while the game has been enabled may be correlated to the game as a useful measure of performance of the game. For instance, if the enabling of the game is correlated to an increase in the theoretical win for the gaming device, then it may be determined (e.g., by a game terminal server) to keep the game enabled based on this increased performance. In another example, the benchmark theoretical win 710 may be of a different gaming device, or may be an average for two or more gaming devices. For instance, such benchmarks may be useful in determining any difference in theoretical win between gaming devices having different games in use.

Although a benchmark theoretical win is described above with respect to a gaming device, it will be readily understood that other types of benchmark values may be used, in addition to or in lieu of a theoretical win value. For example, benchmark values may be established appropriate for comparison with various types of measures of performance, usage, and/or profitability. Some examples of benchmark values include, but are not limited to, a number of handle pulls per hour, a number of paylines activated on a slot machine, and an average wager size per handle pull. Benchmark values may also be established for information related to ancillary entities (e.g., sponsors of offers made available during a game). Some examples include, but are not limited to, a number of restaurant covers, an average price per check (e.g., in a restaurant), an occupancy of a showroom or theater, an average daily room rate at a hotel, and a percentage of rooms that are occupied in a hotel.

The gaming device location 712 stores an indication of where a particular gaming device is located. Such information may be used, for example, to determine whether a game should be enabled on a gaming device. For example, in one embodiment it may be desirable that a particular game be enabled for play of one gaming device in a designated area of a casino per predetermined period of time (e.g., at least once every five minutes for a particular bank of slot machines). Accordingly, the computer 400 may track when the game is enabled and, if this has not occurred within a predetermined period of time in a designated area of a casino, the computer 400 may select a gaming device in that area and instruct it to enable the game for play.

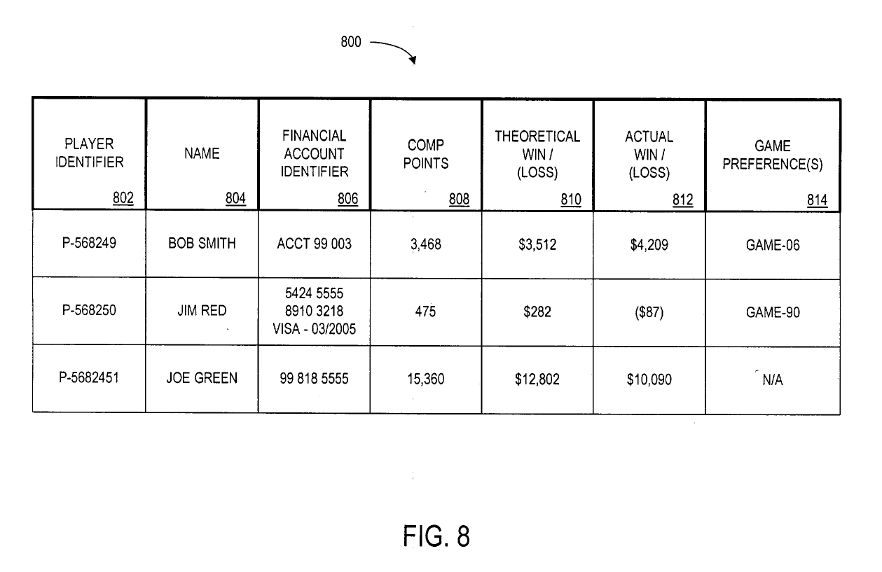

Referring now to FIG. 8, an exemplary tabular representation 800 illustrates an exemplary embodiment of a player database 440 (FIG. 4) that may be stored in computer 400. The tabular representation 800 of the player database includes a number of example records or entries, each defining a player who may be a member of a slot club of a casino or otherwise registered with or known to a casino or other entity. Those skilled in the art will understand that the player database may include any number of entries.

The tabular representation 800 also defines fields for each of the entries or records. The fields specify: (i) a player identifier 802 that uniquely identifies a player, (ii) a name 804 of a player, (iii) a financial account identifier 806 associated with a player, (iv) an indication of comp points 808 available to a player, (v) a theoretical win/[loss] 810, (vi) an actual win/[loss] 812 for a player, and (vii) a game preference(s) 814.

The information in the player database 440 may be created and updated, for example, based on information received from a player, a casino employee, a gaming device 230, a peripheral device 240, and/or peripheral device server 245. For example, the information may be created when a player registers with a casino and receives a player tracking card encoded with the player identifier. The information may be subsequently updated when a player requests to update the information (e.g. when a player indicates a desire to change a preferred game) or when additional information is obtained about the player via the casino's interactions with the player (e.g. the lifetime theoretical win may be updated on an ongoing basis as the player plays games at a casino).

The player identifier 802 may be, for example, an alphanumeric code associated with a player who may operate a gaming device or play a table game at a casino. The player identifier 802 may be generated or selected, for example, by the computer 210 or by the player (e.g., when a player first registers with a casino). For each player, the player database 440 may also store the player's name 804 (e.g., for use in outputting messages to the player). In one or more embodiments the player's name may comprise a nickname or other designation for the player that is selected by the player or the casino. In one or more embodiments, the nickname may comprise a designation that reflects the player's status (e.g., “premium player”). Such a status may indicate, for example, the typical spending range of the player or other indication of how valuable the player is considered to be by the casino. Such a designation may or may not be known to the player.

The financial account identifier 806 (e.g., a credit card account number, a debit card account number, a checking account number, a casino financial account number, or digital payment protocol information) associated with the player. The financial account identifier 806 may be used, for example, to credit a payment to the player (e.g., wherein a benefit obtained by the player comprises a monetary amount) and/or to debit a wager amount.

The comp points 808 stores an indication of the number of comp points that a player is currently entitled to. Comp point programs are a common method for a casino to reward players by awarding points to players as a reward for certain gambling behavior that a casino finds desirable. Although the comp points programs differ from casino to casino, in a typical comp point program a player accumulates comp points based on (i) a total amount of coins wagered, or (ii) a total amount of coins paid out. Alternatively, comp points may be awarded based on, for example, (i) the length of time or a number of game plays at a gaming device or table game; (ii) the average wager of a player; and/or (iii) for playing a particular gaming device or group of gaming devices. As the player accumulates comp points the player may exchange some or all of the comp points for goods or services specified by the comp point program. For example, a player may exchange 800 comp points for a dinner at a casino restaurant. As the player exchanges comp points for a good or service the exchanged comp points are deducted from the player's comp point balance reflected in field 808 of tabular representation 800. In some comp point programs the rewards are defined in terms of dollar amounts rather than points. In yet other comp point programs the points are exchangeable into dollar amounts based on a schedule defined by the casino, allowing the player to convert the accumulated points into dollar amounts and then use the dollar amounts to purchase goods or services from the casino.

The theoretical win/[loss] 810 stores an indication of the theoretical win of the casino based on the playing activity of the player since the playing activity of the player has been tracked. In other words, the historical theoretical win/[loss] 810 may be a “lifetime” theoretical win. In other embodiments a historical theoretical win/[loss] based on other periods of time may be stored in addition to or instead of the lifetime historical theoretical win/[loss]. For example, an annual or session theoretical win/[loss] may be stored. The actual win/[loss] 812 stores an indication of the actual dollar amount that the corresponding player has won or lost while gambling at the casino. A casino loss is indicated in brackets in the tabular representation 800.

In some embodiments of the present invention, a determination of whether to enable a game on a gaming device and/or whether to offer to activate a game for a player may be based on the theoretical win/[loss] and/or actual win/[loss] of the player playing the game. For example, using the process 100D, in step 165 it may be determined if two predetermined conditions have been satisfied: (i) that a player's actual win/[loss] is a loss of at least a predetermined value (assuming, for this example, that the win/[loss] is calculated for a particular gaming session); and (ii) that the gaming device at which the player is playing is compatible with the game. Satisfaction of these two predetermined conditions may correspond to enabling the game for use on the player's gaming device.

It should be understood that although a player identifier and information related to each registered player is described in detail, a player need not be registered in order to be able to use games enabled on a gaming device. Accordingly, registration of a player and storing of information related to a player is not necessary for practice of the present invention.

The game preference(s) 814 store one or more preferences for a game. For example, a preference may be that a particular game is enabled on whatever gaming device the player is playing. Such player preferences may be provided by the player directly. For example, a player may tell a casino employee, who may in turn enter an indication of the preference to the player database. In another example, a player may be prompted by a gaming device 230 to store a current configuration of one or more games as a game preference. Alternatively, a player preference may be determined indirectly. For example, a casino employee may observe a player's reaction and decide that the player really does not like a particular game or that a player really enjoys a particular type of offer that may be provided in accordance with one or more games. In another example of how a player preference may be determined indirectly, a player's gambling behavior may be tracked to determine whether a player continues to keep playing for an extended period of time or stops playing shortly after a particular game is enabled.

According to some embodiments, some or all of the exemplary information depicted in FIG. 8 may be stored on a player tracking card. For example, an indication of one or more game preferences of a player may be stored on a player tracking card and accessed by one or more gaming devices 230, peripheral device server 245, another peripheral device 240, and/or computer 210.

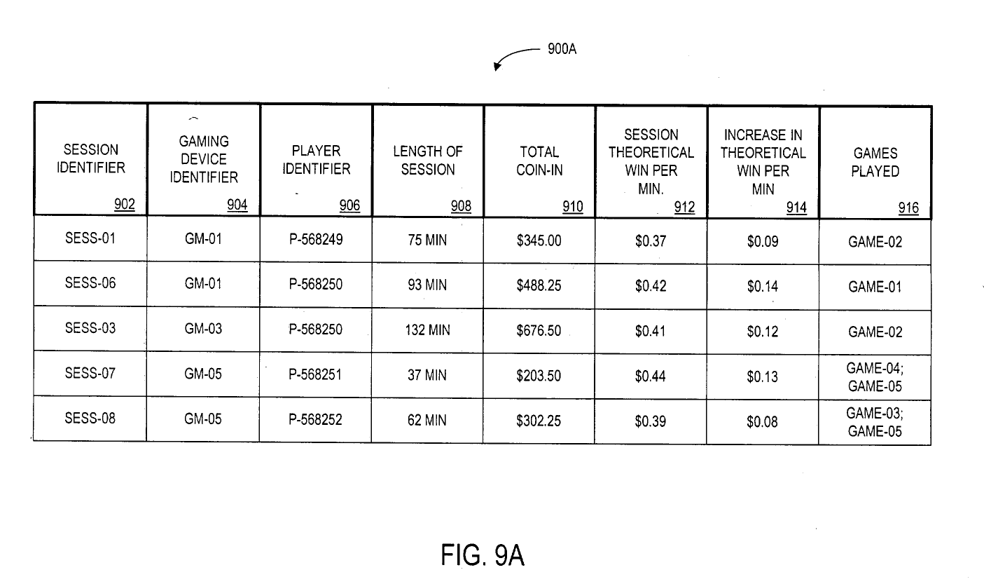

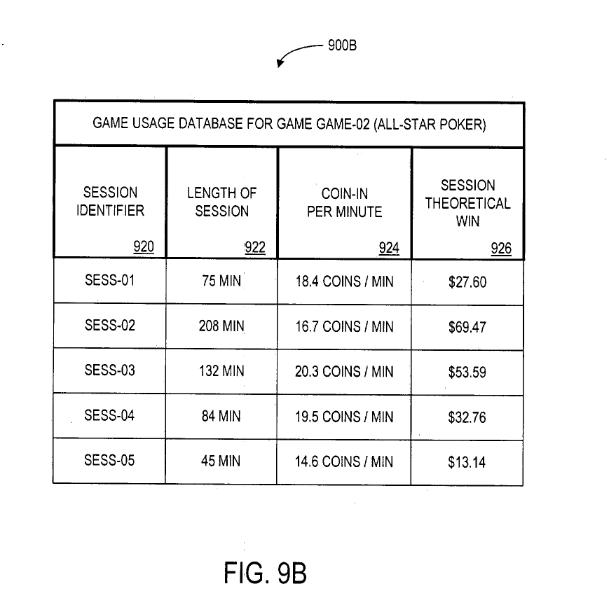

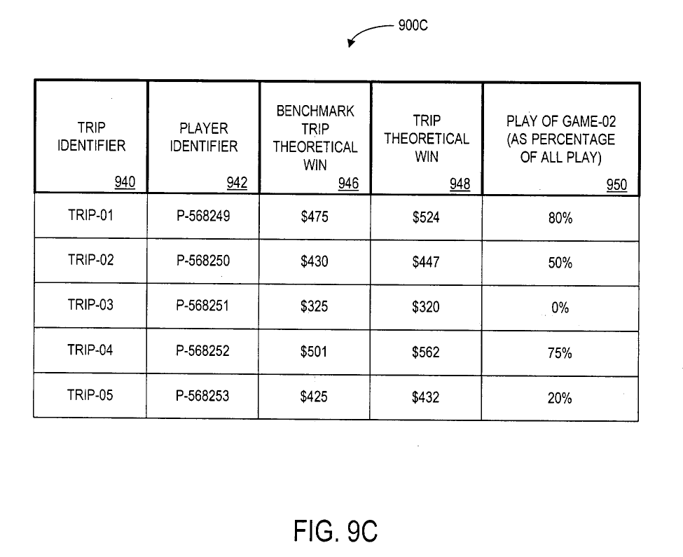

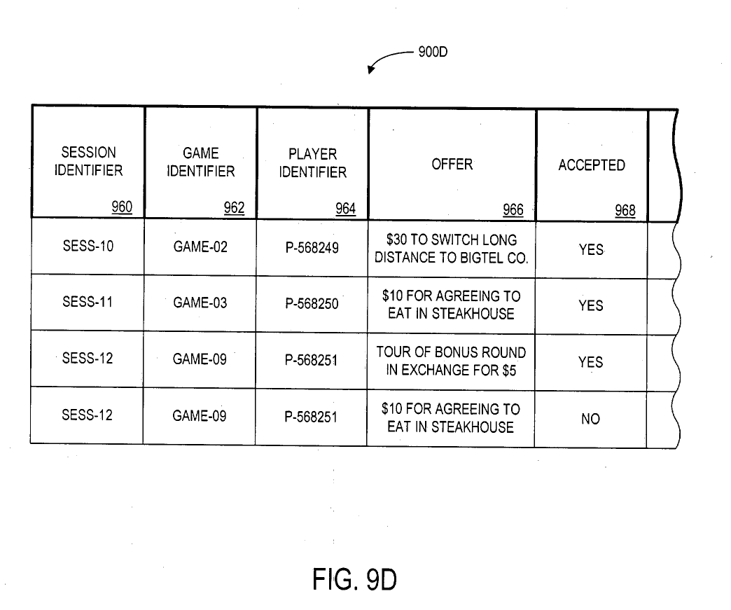

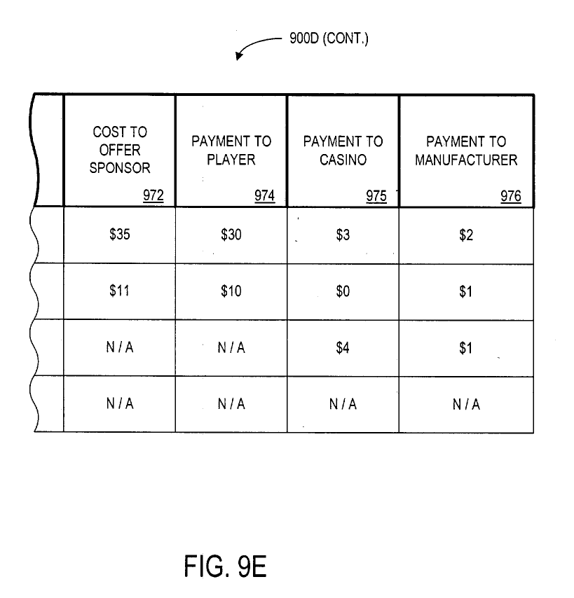

Referring now to FIG. 9A, an exemplary tabular representation 900A illustrates an exemplary embodiment of a performance database 445 (FIG. 4) that may be stored in computer 400. The tabular representation 900A of the performance database includes a number of example records or entries, each defining a gaming session of a player at a gaming device. Those skilled in the art will understand that the performance database may include any number of entries.

The tabular representation 900A also defines fields for each of the entries or records. The fields specify: (i) a session identifier 902 that uniquely identifies a session of gaming activity by a player, (ii) a gaming device identifier 904 that identifies a gaming device at which the player's gaming activity takes place, (iii) a player identifier 906 that identifies a player participating in the gaming session, (iv) a length of session 908 that includes an indication of the duration of the particular gaming session, (v) a total coin-in 910 that indicates a total amount wagered by the player during the session, (vi) a session theoretical win per minute 912, (vii) an increase in theoretical win per minute 914 that indicates a difference between the session theoretical win per win and a particular benchmark value (e.g., benchmark theoretical win 710 of FIG. 7), and (viii) a games played 916 that indicates one or more games that were played during the particular session.

The information in this exemplary embodiment of the performance database 440 may be created and updated, for example, based on information received from a player, a casino employee, a gaming device 230, a peripheral device 240, and/or peripheral device server 245. For example, the information may be created when a player inserts his player tracking card at a gaming device 230 (e.g., a new session entry may be created whenever a player is first identified at a gaming device). The information may be updated subsequently when additional information is obtained about the player via the player's interactions with the gaming device during a session. For example, the total coin-in, and indications of the games played may be updated on an ongoing basis as the player places wagers at the gaming device and selects different games. In another example, the session theoretical win per minute (and the increase in theoretical win per minute) may be updated on an ongoing basis during a session (or, alternatively, only at the end of a session) based on the player's wagering.

Information stored this exemplary embodiment of the performance database 445 may be used in making various determinations for managing games. In some embodiments of the present invention, a determination of whether to enable or disable a game on a gaming device, and/or whether to offer to enable play of a game for a player, may be based on the total coin-in, session theoretical win per minute and/or the increase in theoretical win per minute. For example, using the process 100B, in step 135, the determination of whether to disable one or more enabled games may be based on a measure of performance such as the total coin-in, the session theoretical win per minute, and/or the increase in theoretical win per minute. If the increase in theoretical win per minute is greater than a predetermined value, the enabled games may remain enabled. Otherwise, they may be disabled. Note that such a determination need not take place during the player's session, but may occur at any time (e.g., in accordance with a schedule for managing the games of the system).

In one or more embodiments of the present invention, some of the information stored in the exemplary embodiment of the performance database 445 may be used to determine payment for a provider of a game or gaming device. For example, using the process 100D, in steps 175-185 the total coin-in may be used as a measure of usage in determining a payment

It should be understood that the sessions depicted in the tabular representation 900A are for illustrative purposes only. In some embodiments, a player's session may include information about play of more than one gaming device, and may include information about one or more periods of time in which the player was not playing a gaming device (e.g., the session may correspond to an entire week stay at a casino hotel). FIG. 9C, for example, depicts exemplary information representing a player's trip to a casino, and is discussed in detail below.

Referring now to FIG. 9B, an exemplary tabular representation 900B illustrates another exemplary embodiment of a performance database 445 (FIG. 4) that may be stored in computer 400. The tabular representation 900B of the performance database includes a number of example records or entries, each defining a gaming session in which an exemplary game “All-Star Poker” was played. Those skilled in the art will understand that the performance database may include any number of entries.

The tabular representation 900B also defines fields for each of the entries or records. The fields specify: (i) a session identifier 920 that uniquely identifies a session in which the exemplary game was used, (ii) a length of session 922 that includes an indication of the duration of the particular gaming session, (iii) a coin-in per minute 924 that indicates the total coin-in for the session averaged on a per minute basis, and (iv) a session theoretical win per minute 926.

As discussed above with respect to the tabular representation 900A of FIG. 9A, the information in this exemplary embodiment of the performance database 440 may be created and updated, for example, based on information received from a player, a casino employee, a gaming device 230, a peripheral device 240, and/or peripheral device server 245. Similarly, information may be created at the start of a session (e.g., when a player inserts his player tracking card at a gaming device 230), and may be updated subsequently.

Various types of information represented in this exemplary embodiment may be used in managing games for gaming devices. For example, the length of session 922 may be helpful as a measure of usage (e.g., in determining whether to keep the game enabled, in determining whether to enable the game on additional gaming devices, in determining an amount due to a provider of the game).

As discussed variously herein, a measure of profitability of a gaming device (e.g., based on revenue generated at the gaming device) can be useful in managing games on the gaming device (e.g., in determining whether to enable or disable certain games). In some embodiments, a measure of performance and/or of profitability may take into account payment that might be due one or more providers of a game (e.g., based on its usage).

Referring now to FIG. 9C, an exemplary tabular representation 900C illustrates another exemplary embodiment of a performance database 445 (FIG. 4) that may be stored in computer 400. The tabular representation 900C of the performance database includes a number of example records or entries, each defining a trip or visit of a player to a casino. Those skilled in the art will understand that the performance database may include any number of entries.

The tabular representation 900C also defines fields for each of the entries or records. The fields specify: (i) a trip identifier 940 that uniquely identifies a trip or visit of a player to a gaming establishment (e.g., a casino hotel), (ii) a player identifier 942 that identifies the particular player, (iii) a benchmark trip theoretical win 946, (iv) a trip theoretical win 948, and (v) a play of GAME-02 950 that indicates a percentage of the player's play during the trip that the player was playing the exemplary game identified as “GAME-02”. Information in this exemplary embodiment may be created and/or updated as discussed herein with respect to other described embodiments of the performance database 445.

The trip theoretical win 948 and benchmark trip theoretical win 946 may be used, in a manner similar to that described above with respect to FIG. 9A, to determine a measure of performance of one or more games. The play of GAME-02 950 may be useful as a measure of a player's usage of a particular game during a trip, in determining whether or not to change the games enabled for use on gaming devices. In addition, information about how much of the time a player plays one or more particular games may be useful in determining what games to offer to the player and/or to make available for selection by the player.

Referring now to FIGS. 9D-9E, an exemplary tabular representation 900D illustrates another exemplary embodiment of a performance database 445 (FIG. 4) that may be stored in computer 400. The tabular representation 900D of the performance database includes a number of example records or entries, each defining an offer that was made to a player during a gaming session. Those skilled in the art will understand that the performance database may include any number of entries.

The tabular representation 900D also defines fields for each of the entries or records. The fields specify: (i) a session identifier 960 that identifies a session of gaming activity by a player, (ii) a game identifier 962 that identifies a game being played when the offer was provided, (iii) a player identifier 964 that identifies a player who received the offer, (iv) an offer 966 that includes an indication (e.g., a description, an offer message) of the offer provided to the player, (v) an accepted 968 that indicates whether the offer was accepted, (vi) a cost to offer sponsor 972 that indicates a cost incurred by a sponsor of the offer, (vii) a payment to player 974 that indicates a value of a product, service, or benefit provided to a player, (viii) a payment to casino 975 that indicates value provided to a casino operating the gaming device at which the offer was made, and (ix) a payment to manufacturer 976 that indicates a value provided to a manufacturer of a gaming device or game.

Information in this exemplary embodiment may be created and/or updated as discussed herein with respect to other described embodiments of the performance database 445. For example, the information may be created when an offer is communicated to a player during a game.

Some offers may be sponsored by one or more sponsors. For example, FIGS. 9D-9E depicts an exemplary offer made to a player “P-568249”:“$30 TO SWITCH LONG DISTANCE TO BIGTEL CO.” The player accepted the offer, which may have been made, for example, after a player had wagered a predetermined amount at a gaming device without achieving a winning outcome. The payment to player 974 indicates that the amount of $30 was provided to the player (e.g., by increasing the player's credit balance by $30). In addition, $3 was provided in payment to casino 975, and $2 was provided as payment to manufacturer 976. For example, the sponsor of the offer may have an agreement with the casino that the sponsor will pay the casino a fee (e.g., $3) for each player that accepts its offer. Similarly, the sponsor may agree to pay a $2 fee to the manufacturer of the game for each player that accepts the offer. The cost to offer sponsor 972 indicates that the total cost to the sponsor for the accepted offer was $35. Note that the sponsor may value the player, who has agreed to switch long distance telephone service, in excess of the cost to the sponsor of providing the $35 in benefits and fees to the player and other parties.

Information represented in this exemplary embodiment of the performance database 445 may be used in making various determinations for managing games. In some embodiments of the present invention, a determination of whether to enable or disable a game on a gaming device, and/or whether to offer to activate a game for a player, may be based on the number of offers made during the game that have been accepted. Thus, the number of accepted offers (or the percentage of offers made that were accepted, etc.) may be a useful measure of performance and/or usage of the game. For example, a game that corresponds to a low rate of acceptance of offers may be disabled.

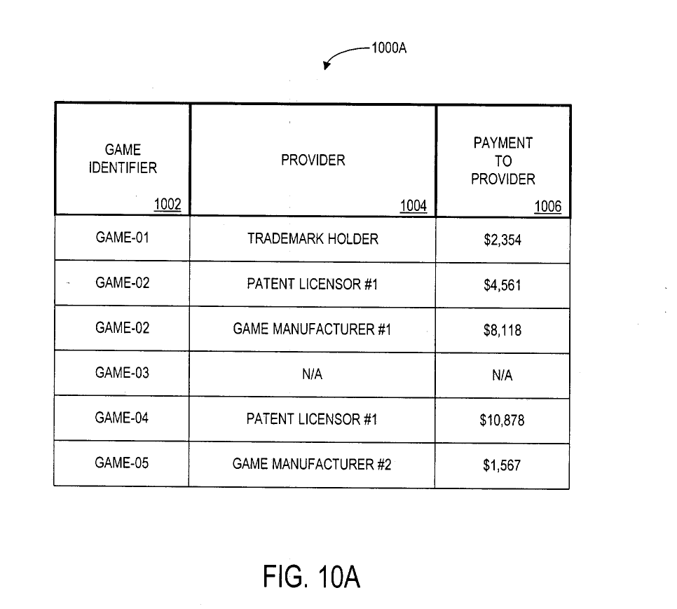

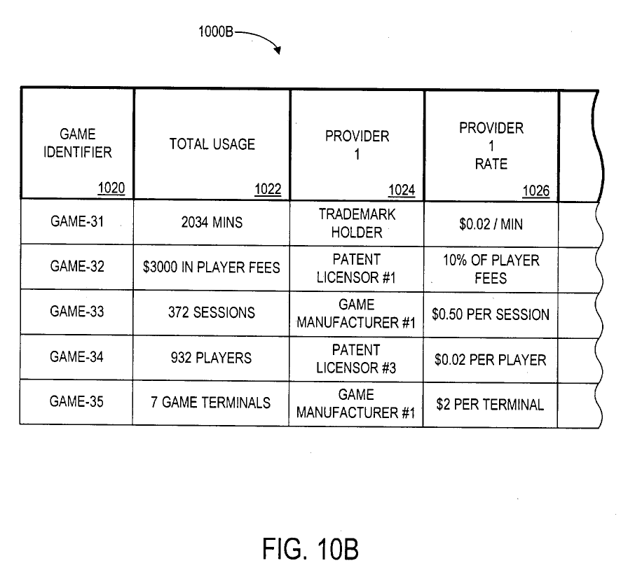

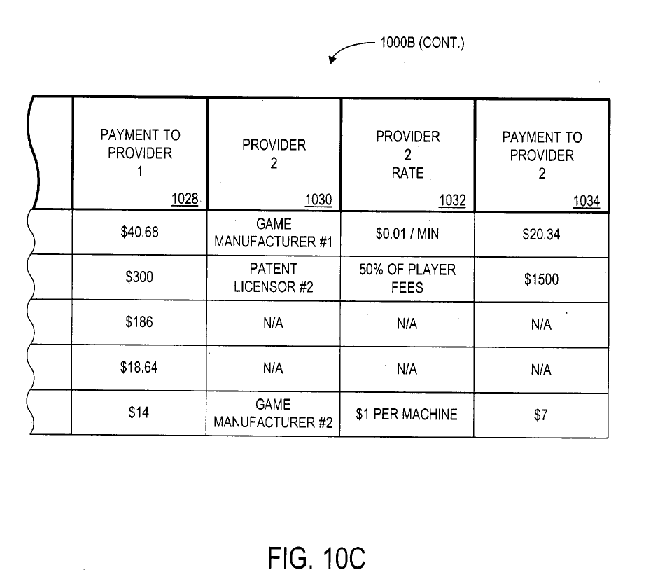

Referring now to FIG. 10A, an exemplary tabular representation 1000A illustrates an exemplary embodiment of a payment database 450 (FIG. 4) that may be stored in computer 400. The tabular representation 1000A of the payment database includes a number of example records or entries, each defining a payment made to a provider of a game. Those skilled in the art will understand that the player database may include any number of entries.

The tabular representation 1000A also defines fields for each of the entries or records. The fields specify: (i) a game identifier 1002 that identifies a game, (ii) a provider 1004 that indicates a party that provided the game or otherwise has a proprietary interest in the game, and (iii) a payment to provider 1006 that indicates an amount paid (or to be paid) to the particular provider. Note that one game may be associated with two or more providers. For example, game “GAME-02” is associated with both “PATENT LICENSOR #1” and “GAME MANUFACTURER #1”.

As discussed herein, payment to a provider of a game may be determined based on a variety of types of information and measures of performance, usage, and/or profitability. In addition, as discussed below with respect to FIGS. 10B-10C, payment may be based at least in part on one or more applicable payment rates.

Referring now to FIGS. 10B-10C, an exemplary tabular representation 1000B illustrates an exemplary embodiment of a payment database 450 (FIG. 4) that may be stored in computer 400. The tabular representation 1000B of the payment database includes a number of example records or entries, each defining payment information for a particular game. Those skilled in the art will understand that the player database may include any number of entries.

The tabular representation 1000B also defines fields for each of the entries or records. The fields specify: (i) a game identifier 1020 that uniquely identifies a game, (ii) a total usage 1022 that indicates a measure of usage of the particular game, (iii) a provider 1 field 1024 that identifies a party that provided the game or otherwise has a proprietary interest in the game, (iv) a provider 1 rate 1026 that indicates a rate for use in determining payment for provider 1, (v) a payment to provider 1 field 1028 that indicates a value provided (or due) to provider 1, (vi) a provider 2 field 1030 that identifies another party that provided the game or otherwise has a proprietary interest in the game, (vii) a provider 2 rate 1032 that indicates a rate for use in determining payment for provider 2, and (viii) a payment to provider 2 field 1034 that indicates a value provided (or due) to provider 2. Note that, as in FIG. 10A, one game may be associated with two or more providers.

The total usage 1022 indicates information that may be used for determining payment due to one or more providers of games and/or gaming devices. Such information may be updated as discussed above with respect to the exemplary embodiments of the performance database 445. For example, gaming activity may be monitored and updated on an ongoing basis by one or more of the computer 210, the gaming device 230, and/or a peripheral device 240. Examples of measures of usage appropriate for use with one or more embodiments of the present invention include, but are not limited to: (i) a total number of minutes used, (ii) a total revenue generated, (iii) a number of sessions in which the game was enabled and/or played, (iv) a number of players playing the game, and (v) a number of gaming devices at which the game was enabled and/or played. Of course, as discussed variously herein, measures of usage may also be useful in managing the enablement of games (e.g., in order to adjust the performance of a game management system).

The rates 1026 and 1032 depict various exemplary types of rates that may be used in determining payment to licensors, vendors, and other providers, such as per-unit time rates, percentage of revenue rates, fee per user rates, and fee per gaming device rates. Other appropriate types of rates will be recognized by one of ordinary skill in the art after reading the present application.

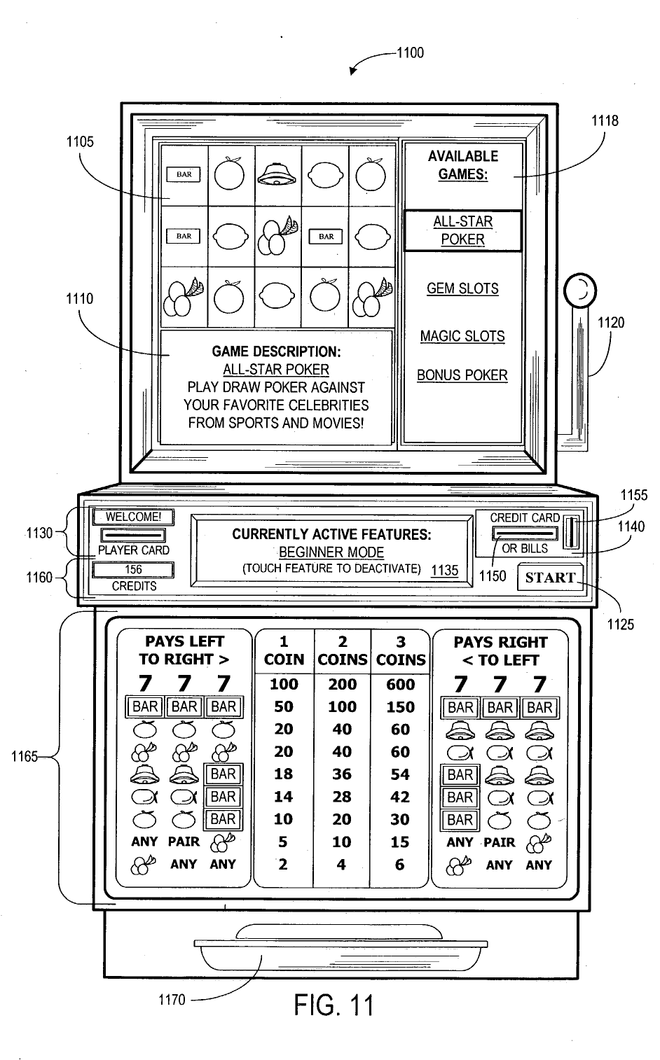

Referring now to FIG. 11, an embodiment 1100 of a plan view of a gaming device 230 is illustrated. In the embodiment 1100, the gaming device 230 comprises a five reel slot machine. The slot machine 1100 comprises a display area 1105 in which an outcome for a game of the slot machine is displayed to the player. The display area 1105 may, for example, be a video display that displays simulations of reels. The display area 1105 may, in another example, be glass behind which are located mechanical reels. Display area 1105 is an exemplary embodiment of the display device 355, described with respect to FIG. 3.

The slot machine 1100 also comprises a display area 1110 in which information about one or more games, such as descriptions of games, is displayed to the player. The display area 1110 may, for example, be a video display that displays images and/or text. Display area 1110 is another exemplary embodiment of the display device 355, described with respect to FIG. 3.

The slot machine 1100 further comprises a display area 1118 in which images or text indicating available games for play of the slot machine 110 are displayed to the player. The display area 1118 may, for example, be a video display that displays images and/or text, and that may include a touch screen. Display area 1118 is another exemplary embodiment of the display device 355, described with respect to FIG. 3.

Slot machine 1100 further comprises a handle 1120. A player may initiate the movement of the reels in display area 1105 by pulling on the handle 1120. Alternatively, a player may initiate the movement of the reels in display 1105 by actuating the start button 1125. Either or both of handle 1120 and start button 1125 are exemplary embodiments of the input device 365, described with respect to FIG. 3.

Slot machine 1100 also comprises a player tracking device 1130, which is an example of the player tracking device 360 that was described with respect to FIG. 3. The player tracking device 350 may comprise a player tracking card reader and a display (e.g., an LED display) for outputting information related to the player identifier (e.g., player's name and number of comp points associated with player's account).

Also a component of slot machine 1100 is another display area 1135, for outputting information to a player. The display area 1135 may be utilized, for example, to inform a player of which features, if any, are currently active on the slot machine 1100 and/or may provide a way for the player to deactivate an active feature. The display area 1135 may, for example, be a video display including a touch screen. Display area 1135 is another exemplary embodiment of the display device 355, described with respect to FIG. 3.

Payment system 1140, an exemplary embodiment of payment system 375, comprises a bill acceptor and/or a credit card reader 1150, and a coin acceptor 1155. A player may utilize payment system 1140 to provide a wager for playing a game and/or for providing payment for provision of a game available on slot machine 1100.

Slot machine 1100 further comprises a credit meter balance 1160, which is an exemplary embodiment of a benefit output device 350 that was described with respect to FIG. 3. The credit meter balance reflects the amount of electronic credits currently available to a player. The electronic credits may be used by a player, for example, as wagers for games played on the gaming device. The electronic credits may also be “cashed out” as coins, bills, tokens, a cashless gaming receipt, and/or credits to another financial account associated with the player.

The slot machine 1100 includes yet another display area, display area 1165, which displays a payout schedule of the slot machine 1100. The payout schedule displays payouts that correspond to various outcomes obtainable on the slot machine 1100. In one or more embodiments, if an outcome is displayed in display area 1105 that, as indicated in display area 1165, corresponds to a payout, the credit meter balance 1160 may be increased by an amount of electronic credits corresponding to the payout.

Finally, the slot machine 1100 comprises a coin tray 1170. Payment to the player may be rendered by dispensing coins into the coin tray 1170. Such coins may be dispensed based on, for example, a player's indication that the player would like to cash out his credit meter balance and/or a payout obtained by a player as a result of playing a game on the slot machine 1100. The coin tray 1100 is an exemplary embodiment of the benefit output device 350, described with respect to FIG. 3. Note that slot machine 1100 may include different and/or additional components besides those illustrated in FIG. 11.

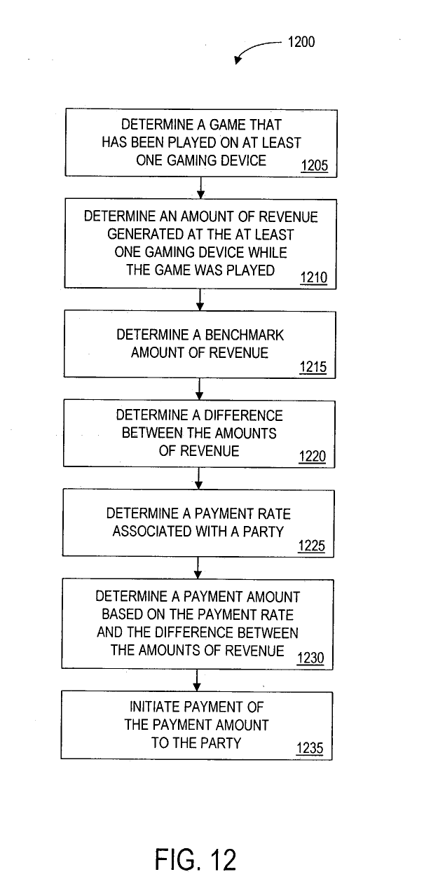

Referring now to FIG. 12, a flowchart illustrates a process 1200 that is consistent with one or more embodiments of the present invention. The process 1200 is a method for determining a payment based on a measure of performance, in which the measure of performance involves determining a difference between two measures of usage for one or more gaming devices. For illustrative purposes only, the process 1200 is described as utilizing an amount of revenue generated as the measure of usage. Of course, the process 1200 may be adjusted for any type of measure of usage (e.g., an amount wagered, a number of product/service offers accepted, a theoretical win, etc.). Also for illustrative purposes only, the process 1200 is described as being performed by a game terminal server. Of course, the process 1200 may be performed by a gaming device 230 and/or a computer 210.

In step 1205 the game terminal server determines a game that has been active on at least one gaming device. For example the slot sever looks up information stored in the gaming device 435 and/or the performance database 445 and identifies a game that has been in use of one or more gaming devices. In step 1210, the game terminal server determines an amount of revenue generated at the at least one gaming device while the game was active. For example, by reference to a performance database that stores indications of use of games by session, as in tabular representation 900A (FIG. 9A), the game terminal server could determine the total coin-in 910 and the games played 916 for each session. For instance, in “SESS-01”, a total of “345.00” was received while “GAME-02” was played.

In step 1215, the game terminal server determines a benchmark amount of revenue. The second amount of revenue may be revenue generated at the at least one gaming device, may have been generated at one or more other gaming devices, or may be some other amount being used as a benchmark. For example, the game terminal server may determine that the benchmark amount of revenue is equal to a revenue projection for the at least one gaming device.

In step 1220, the game terminal server determines a difference between the amount of revenue generated while the game was active and the benchmark amount. In other words, the game terminal server compares the two amounts to determine a measure of performance of the game. For example, if the benchmark amount is less than the amount of revenue generated, the difference by which the revenue exceeded the benchmark value may be correlated to the use of the game on the at least one gaming device.

In step 1225, the game terminal server determines a payment rate that is associated with a party (e.g., a proprietor or other provider of the game) and in step 1230 determines a payment amount based on the payment rate and the difference between the amount of revenue generated and the benchmark amount. For example, the game terminal server looks up the appropriate payment rate for the game in payment database 450. For instance, the payment rate may be a flat rate payable only if the benchmark is exceeded. In another example, the payment rate may be based on the amount of the difference, such as a percentage (e.g., 5%) of the difference. In step 1235, the game terminal server initiates payment of the payment amount to the party. For example, the game terminal server may send an indication of the usage statistics to the party, and the party may confirm the amounts and bill the casino. In another example, the game terminal server may provide payment (e.g., via an electronic funds transfer).

It should be noted that, similar to the determinations in process 10B, process 1200 may further include a determination of whether the game should remain enabled on one or more gaming devices. Such a determination may be based, for example, on a determination of whether a predetermined condition has been satisfied (e.g., whether the difference is greater than a predetermined increase in revenue). Such a predetermined condition may comprise a condition similar to those described with respect to step 165 of process 100D.

According to some alternative embodiments of the present invention, systems and methods for managing games, determining measures of performance of games and devices, and/or determining payment owed to proprietors and providers of games and devices may be applied to industries other than gaming, such as the industries for vending machines and other point-of-sale terminals.

According to various embodiments of the present invention, a provider of a gaming device and/or game (e.g., a trademark holder, a game manufacturer, a controller) may provide an indication of at least one authorization code (e.g., to a sever computer, to a gaming device). The authorization code may be used in determining whether to enable or disable one or more games (e.g., of one or more gaming devices, of one or more gaming systems).

An authorization code (e.g., a password, an access code, an authentication code) may comprise any of various types of information suitable for indicating that an entity having the code (e.g., a game terminal server, a slot machine) is permitted to enable and/or disable a game. For example, an authorization code may comprise, without limitation, one or more alphanumeric characters, a sequence of digits, a digital certificate, and/or a combination thereof. In some alternative embodiments, the authorization code may comprise all or a portion of a program for using, enabling, and/or disabling the game.

According to one embodiment, an authorization code may be indicated to a server computer (e.g., a slot machine server). For example, an employee of a casino may input an authorization code when prompted by a game terminal server in accordance with a program for managing games in a game terminal network. The controller (and/or the employee) may then be permitted to enable or disable one or more games in accordance with the authorization code (e.g., based on a stored condition for enabling a game). Alternatively, or in addition, an indication of an authorization code may be provided to a gaming device. The gaming device may then enable or disable games as appropriate.

An authorization code may be provided by any one or more of a variety of different parties. For example, a casino (e.g., a representative of a casino, such as a slot host, system administrator, or other employee) may provide an authorization code (e.g., to a game terminal server, to a gaming device). In another example, a regulatory body or group (e.g., a state, federal, or local government regulating agency; an industry regulatory or standardization group) may provide an authorization code for a game. For example, if a state regulatory agency does not approve of a game, then it may refuse to issue an authorization code for the game, thereby preventing the game from being enabled on gaming devices. Alternatively, the agency may issue an authorization code that disables a previously-enabled game. In another example, the state regulatory agency may mandate that a particular game be enabled, and may issue a corresponding authorization code. A proprietor of a game (e.g., a game manufacturer, a patent holder) may provide an authorization code. For example, a game manufacturer may sell authorization codes for a particular game. In another example, in order to enable a pre-installed game (e.g., a program including instructions for providing the game was previously provided to a casino) on a gaming device, a casino can purchase the appropriate authorization code from the game manufacturer.

According to some embodiments, an authorization code may be generated in a manner so as to prevent, discourage, or make computationally unfeasible forgery of authorization codes (e.g., using cryptographic techniques). An authorization code may be generated by a trusted third party. For example, a proprietor may request that a third party generate an authorization code. The third party may generate the code and transmit the code to the requesting party. Alternatively, or in addition, the third party may transmit the authorization code to a controller, a player, or a gaming device for use in accordance with various embodiments of the present invention.

According to some embodiments of the present invention, it may be difficult or impossible to enable a game of a game or a gaming device without an authorization code. For example, a casino may not be able to enable a particular game unless an authorization code has been received (e.g., from a proprietor of the game). In another example, a gaming device may not be able to provide for a game unless the authorization code has been provided to the gaming device (e.g., by a controller, by a game manufacturer). Similarly, according to some embodiments, it may be difficult or impossible to disable a game of a game or a gaming device without a corresponding authorization code.

In one or more embodiments, an authorization code may enable a game and prevent subsequent disabling of the game (e.g., for a predetermined minimum number of uses of the game). Similarly, in some embodiments an authorization code may disable a game and prevent enabling of the game (e.g., for a period of time).

In one or more exemplary embodiments for enabling a game, the authorization code provides a processor or operator of a gaming system with access to a file, storage device, program, and/or program module that is necessary to enable or disable a game. For example, in a manner known in the art, a program for providing one or more games in a gaming system may require that an operator of the system provide an appropriate authorization code (e.g., a password, an access code) before allowing a game to be enabled. One or more authorization codes may be stored, for example, in game database 425 (FIG. 4). According to some embodiments of the present invention, an authorization code may be required in order to add, delete, or modify one or more conditions for enabling and/or disabling a game.

A condition for whether to enable and/or disable a game may be related to one or more authorization codes. In some exemplary embodiments, a condition for enabling a game may require that one or more authorization codes have been provided. For example, in order for a casino to enable an “All-Star Poker” game on its gaming device network, the casino may have to acquire one authorization code from the owner of a patent for “All-Star Poker” and another authorization code from the manufacturer of the casino's game terminals at which “All-Star Poker” can be enabled. Accordingly, to enable the “All-Star Poker” game, the slot network controller determines whether or not the two authorization codes have been received (i.e. whether the exemplary condition for enabling “All-Star Poker” is satisfied).

According to one embodiment, a plurality of authorization codes may be required to enable a game. For example, a game on a gaming device may only be enabled if a first authorization code is provided by a first party (e.g., a regulator) and a second authorization code is provided by a second party (e.g., a proprietor). Alternatively, an authorization code may comprise multiple parts that may be provided by multiple parties. Of course, a plurality of authorization codes (or parts of an authorization code) may be provided by one party rather than multiple parties.

In some exemplary embodiments, whether or not a game may be enabled and/or disabled may be based on a period of time since an authorization code was provided. For example, the authorization code may have an associated period of validity (e.g., thirty days after providing of the authorization code, thirty days after a corresponding game is enabled or disabled). After the associated period of time (e.g., when the authorization code “expires”), a controller, for example, may be prevented from enabling and/or disabling a game. Thus, a casino may be allowed by a proprietor (or a regulatory body, etc.) to enable a game for only a limited period of time. Conversely, a casino may be prevented by a proprietor of a game from disabling the game until after the game is used for a minimum period of time. In some embodiments, a new authorization code must be provided after (or before) the period of time in order to allow for enabling and/or disabling of the game (e.g., by a controller, by a gaming device). Alternatively, or in addition, an authorization code may have an expiration date after which the authorization code is no longer valid for enabling and/or disabling one or more games.

In other exemplary embodiments, whether or not a game may be enabled and/or disabled may be based on an amount of use of a game (e.g., since an authorization code was provided, since a corresponding game was enabled or disabled). For example, the authorization code may be associated with a number of plays of a game (e.g., 500 plays in a gaming system, five plays by a player, 200 plays at a gaming device). Thus, a casino may be allowed to enable a game for only a limited period of time based on the provided authorization code. Conversely, a casino may be prevented from disabling an enabled game until the game has been used a minimum number of times. Of course, usage of a game may be measured in various ways other than a number of uses, as discussed herein. For example, an authorization code may expire after an associated total wager amount in games using the game.

According to one or more embodiments of the present invention, a game may be automatically disabled or enabled if an authorization code is not provided in accordance with various criteria. Examples of predetermined conditions that must be satisfied for automatically disabling or enabling a game include, but are not limited to:

(i) requiring that an authorization code be entered every thirty days to keep a game enabled on a gaming device;

(ii) requiring that an authorization code be entered every two hundred thousand spins to keep a slot machine game enabled; and

(iii) requiring that an authorization code be provided in order to disable a game at one or more gaming devices.

A game may be associated with more than one authorization code (or type of authorization code). For example, one authorization code may allow a casino to enable a game for thirty days at a first type of gaming device at any time of day, and a different authorization code may permit a casino to enable the same game for a year at a different type of gaming device only during peak hours. Accordingly, determining whether a condition for enabling and/or disabling a game is satisfied may include determining the type of authorization code provided.

An authorization code in accordance with various embodiments of the present invention may allow for enabling and/or disabling of: (i) multiple (or all) games for multiple (or all) games on multiple (or all) gaming devices; (ii) multiple (or all) games for multiple (or all) games on one gaming device (e.g., a different code is needed for a different gaming device, an authorization code is associated with a particular gaming device); (iii) multiple (or all) games for one game on multiple (or all) gaming devices (e.g., a different code is needed for a different game, an authorization code is associated with only one game); (iv) multiple (or all) games for one game on one gaming device (e.g., a different code is needed for a different game on the same gaming device, or for the same game on a different gaming device; an authorization code is associated with only one gaming device and with only one game); (v) one game for multiple (or all) games on multiple (or all) gaming devices (e.g., a different code is needed for a different game, an authorization code is associated with only one game); (vi) one game for multiple (or all) games on one gaming device (e.g., a different code is needed for a different game on the same gaming device, or for the same game on a different gaming device; an authorization code is associated with only one game and with only one gaming device); (vii) one game for one game on multiple (or all) gaming devices (e.g., a different code is needed for a different game in the same game, or for the same game in a different game; an authorization code is associated with only one game and with only one game); and (viii) one game for one game on one gaming device (e.g., a different code is needed for every single game on every single game on every single gaming device, an authorization code is associated with only one game and with only one game and with only one gaming device).

Thus, according to one exemplary embodiment of the present invention, one or more authorization codes may be used to enable or disable only a single game on only a single gaming device. Thus, an additional authorization code (or codes) may be necessary to enable or disable a different game on the same gaming device, and an additional authorization code (or codes) may be necessary to enable or disable the same game on a different gaming device. Such an embodiment would prevent a casino, for example, from using the same authorization code to enable the same game on multiple gaming devices and/or to enable multiple games on one or more gaming devices.

In conclusion, while the methods and apparatus of the present invention have been described in terms of particular embodiments, those skilled in the art will recognize that the present invention may be practiced with modification and alteration without departing from the teachings disclosed herein.

What is claimed is:

1. A method comprising:
determining a measure of usage of a first game on a first gaming device;
determining a measure of usage of a second game on the first gaming device;
determining a first payment rate that is associated with a first party;
determining a first payment amount based on the first payment rate and the measure of usage of the first game;
initiating payment of the first payment amount to the first party;
determining a second payment rate that is associated with a second party;
determining a second payment amount based on the second payment rate and the measure of usage of the second game; and
initiating payment of the second payment amount to the second party.

2. A method comprising:
enabling a first game for use on a first gaming device;
determining a measure of profitability of the first gaming device,
in which the measure of profitability corresponds to play of the first game on the first gaming device;
determining a difference between the measure of profitability and a benchmark measure of profitability;
determining whether to disable the first game based on the difference; and
disabling the first game on the first gaming device if the first game should be disabled based on the difference.

3. The method of claim 2, further comprising:
disabling the first game on a second gaming device if the first game should be disabled based on the difference.

4. The method of claim 2, further comprising:
enabling a second game on the first gaming device if the first game should be disabled based on the difference.

5. The method of claim 2, further comprising:
enabling a second game on the first gaming device if the first game should not be disabled based on the difference.

6. The method of claim 2, further comprising:
determining a payment amount based on the difference; and
initiating payment of the payment amount to a party.

7. The method of claim 2, further comprising:
determining a payment rate that is associated with the first feature;
determining a payment amount based on the payment rate; and
initiating payment of the payment amount to a party.

8. A method comprising:
determining a measure of usage of a game on at least one gaming device;
determining a payment amount based on the measure of usage of the game; and
initiating payment of the payment amount to a party having an interest in the game.

9. The method of claim 8, further comprising:
determining if the game should be disabled on the at least one gaming device based on the measure of usage of the game; and
disabling the game on the at least one gaming device if the game should be disabled.

10. The method of claim 8, in which determining the measure of usage of the game comprises:
determining an amount of coin-in received at the at least one gaming device.

11. The method of claim 8, in which determining the measure of usage of the game comprises:
determining a period of time that the game is played on the at least one gaming device.

12. The method of claim 8, in which determining the measure of usage of the game comprises:
providing at least one offer for a product to at least one player; and
determining a number of accepted offers of the at least one offer provided.

13. The method of claim 8, in which determining the measure of usage of the game comprises:
providing at least one offer for a product to at least one player; and
determining a transaction amount based on at least one accepted offer of the at least one offer provided.

14. A method comprising:
determining a game that has been active on at least one gaming device;
determining a measure of performance of the game;
determining a payment rate that is associated with a party;
determining a payment amount based on the payment rate and the measure of performance of the game; and
initiating payment of the payment amount to the party.

15. The method of claim 14, in which the party is at least one of:
a licensor of the game,
a developer of the game, and
a vendor of the game.

16. The method of claim 14, in which determining the measure of performance of the game comprises:
determining a first theoretical win that is associated with the at least one gaming device;
determining a second theoretical win based on play of the game; and
determining a difference between the first theoretical win and the second theoretical win.

17. The method of claim 14, in which determining the measure of performance of the game comprises:
determining a first amount wagered at the at least one gaming device;
determining a second amount wagered on play of the game; and
determining a difference between the first amount wagered and the second amount wagered.

18. The method of claim 14, in which determining the measure of performance of the game comprises:
determining a measure of profitability of the at least one gaming device.

19. The method of claim 18, in which determining the measure of profitability of the game comprises:
determining an amount wagered at the at least one gaming device for play of the game; and
determining an amount paid out at the at least one gaming device during play of the game.

20. The method of claim 19, further comprising:
determining a difference between the amount wagered and the amount paid out.

21. The method of claim 18, in which determining the measure of profitability of the game comprises at least one of:
determining an average amount wagered per player at the at least one gaming device for play of the game;
determining an average amount wagered per play at the at least one gaming device for play of the game;
determining an average amount wagered per a unit of time at the at least one gaming device for play of the game; and
determining an average rate of play at the at least one gaming device for play of the game.

22. The method of claim 14, in which determining the measure of performance of the game comprises:
determining an amount of coin-in received at the least one gaming device.

23. The method of claim 14, in which determining the measure of performance of the game comprises:
determining a period of time that the game has been played on the at least one gaming device.

24. The method of claim 14, in which determining the measure of performance of the game comprises:
determining a number of at least one offer provided to at least one player during play of the game,
in which the at least one offer was accepted.

25. The method of claim 14, in which determining the measure of performance of the game comprises:
determining a transaction amount corresponding to at least one accepted offer,
in which the at least one accepted offer was provided to at least one player during play of the game.
